(19) United States
(12) Patent Application Publication
(10) Pub. No.: US 2025/0123472 A1
(43) Pub. Date: Apr. 17, 2025

(54) ZOOM LENS AND IMAGE CAPTURING APPARATUS INCLUDING THE SAME

(71) Applicant: CANON KABUSHIKI KAISHA, Tokyo (JP)

(72) Inventor: YUKI SHINZATO, Saitama (JP)

(21) Appl. No.: 18/915,887

(22) Filed: Oct. 15, 2024

(30) Foreign Application Priority Data
Oct. 16, 2023 (JP) 2023-178515

(51) Int. Cl. G02B 15/14

(52) U.S. Cl. CPC G02B 15/144515

(57) ABSTRACT

A zoom lens includes a first lens unit having negative refractive power, a second lens unit, an intermediate unit including one or more lens units, and a final lens unit, which are arranged in this order from an object side to an image side and in which an interval between adjacent lens units changes during zooming, wherein the first lens unit includes two or more lenses, wherein the intermediate unit includes a first intermediate lens unit and a second intermediate lens unit arranged adjacent to the image side of the first intermediate lens unit, and wherein the first lens unit and the first intermediate lens unit do not move during zooming.

### BACKGROUND

### Technical Field

The aspect of the embodiments relates to an optical system and is suitable for a digital video camera, a digital still camera, a broadcast camera, a silver halide film camera, a surveillance camera, and the like.

### Description of the Related Art

In recent years, there is a demand for zoom lenses having an electric zoom function because they are suitable for capturing moving images and the like.

According to Japanese Patent Application Laid-Open No. 2021-196449, a negative lead type zoom lens is discussed in which each lens unit including a first lens unit is moved during zooming.

### SUMMARY

According to an aspect of the embodiments, a zoom lens includes a first lens unit having negative refractive power, a second lens unit, an intermediate unit including one or more lens units, and a final lens unit, which are arranged in this order from an object side to an image side and in which an interval between adjacent lens units changes during zooming, wherein the first lens unit includes two or more lenses, wherein the intermediate unit includes a first intermediate lens unit and a second intermediate lens unit arranged adjacent to the image side of the first intermediate lens unit, and wherein the first lens unit and the first intermediate lens unit do not move during zooming.

Further features of the embodiments will become apparent from the following description of exemplary embodiments with reference to the attached drawings.

### BRIEF DESCRIPTION OF THE DRAWINGS

FIG. 1 is a cross-sectional view of a zoom lens according to a first exemplary embodiment at a wide angle end, an intermediate zoom position, and a telephoto end.

FIGS. 2A, 2B, and 2C are aberration diagrams at the wide angle end, the intermediate zoom position, and the telephoto end of the zoom lens according to the first exemplary embodiment focused on an object at infinity.

FIG. 3 is a cross-sectional view of a zoom lens according to a second exemplary embodiment at a wide angle end, an intermediate zoom position, and a telephoto end.

FIGS. 4A, 4B, and 4C are aberration diagrams at the wide angle end, the intermediate zoom position, and the telephoto end of the zoom lens according to the second exemplary embodiment focused on an object at infinity.

FIG. 5 is a cross-sectional view of a zoom lens according to a third exemplary embodiment at a wide angle end, an intermediate zoom position, and a telephoto end.

FIGS. 6A, 6B, and 6C are aberration diagrams at the wide angle end, the intermediate zoom position, and the telephoto end of the zoom lens according to the third exemplary embodiment focused on an object at infinity.

FIG. 7 is a cross-sectional view of a zoom lens according to a fourth exemplary embodiment at a wide angle end, an intermediate zoom position, and a telephoto end.

FIGS. 8A, 8B, and 8C are aberration diagrams at the wide angle end, the intermediate zoom position, and the telephoto end of the zoom lens according to the fourth exemplary embodiment focused on an object at infinity.

FIG. 9 is a cross-sectional view of a zoom lens according to a fifth exemplary embodiment at a wide angle end, an intermediate zoom position, and a telephoto end.

FIGS. 10A, 10B, and 10C are aberration diagrams at the wide angle end, the intermediate zoom position, and the telephoto end of the zoom lens according to the fifth exemplary embodiment focused on an object at infinity.

FIG. 11 is a cross-sectional view of a zoom lens according to a sixth exemplary embodiment at a wide angle end, an intermediate zoom position, and a telephoto end.

FIGS. 12A, 12B, and 12C are aberration diagrams at the wide angle end, the intermediate zoom position, and the telephoto end of the zoom lens according to the sixth exemplary embodiment focused on an object at infinity.

FIG. 13 is a cross-sectional view of a zoom lens according to a seventh exemplary embodiment at a wide angle end, an intermediate zoom position, and a telephoto end.

FIGS. 14A, 14B, and 14C are aberration diagrams at the wide angle end, the intermediate zoom position, and the telephoto end of the zoom lens according to the seventh exemplary embodiment focused on an object at infinity.

FIG. 15 is a cross-sectional view of a zoom lens according to an eighth exemplary embodiment at a wide angle end, an intermediate zoom position, and a telephoto end.

FIGS. 16A, 16B, and 16C are aberration diagrams at the wide angle end, the intermediate zoom position, and the telephoto end of the zoom lens according to the eighth exemplary embodiment focused on an object at infinity.

FIG. 17 is a cross-sectional view of a zoom lens according to a ninth exemplary embodiment at a wide angle end, an intermediate zoom position, and a telephoto end.

FIGS. 18A, 18B, and 18C are aberration diagrams at the wide angle end, the intermediate zoom position, and the telephoto end of the zoom lens according to the ninth exemplary embodiment focused on an object at infinity.

FIG. 19 is a cross-sectional view of a zoom lens according to a tenth exemplary embodiment at a wide angle end, an intermediate zoom position, and a telephoto end.

FIGS. 20A, 20B, and 20C are aberration diagrams at the wide angle end, the intermediate zoom position, and the telephoto end of the zoom lens according to the tenth exemplary embodiment focused on an object at infinity.

FIG. 21 is a cross-sectional view of a zoom lens according to an eleventh exemplary embodiment at a wide angle end, an intermediate zoom position, and a telephoto end.

FIGS. 22A, 22B, and 22C are aberration diagrams at the wide angle end, the intermediate zoom position, and the telephoto end of the zoom lens according to the eleventh exemplary embodiment focused on an object at infinity.

FIG. 23 is a cross-sectional view of a zoom lens according to a twelfth exemplary embodiment at a wide angle end, an intermediate zoom position, and a telephoto end.

FIGS. 24A, 24B, and 24C are aberration diagrams at the wide angle end, the intermediate zoom position, and the telephoto end of the zoom lens according to the twelfth exemplary embodiment focused on an object at infinity.

FIG. 25 is a cross-sectional view of a zoom lens according to a thirteenth exemplary embodiment at a wide angle end, an intermediate zoom position, and a telephoto end.

FIGS. 26A, 26B, and 26C are aberration diagrams at the wide angle end, the intermediate zoom position, and the telephoto end of the zoom lens according to the thirteenth exemplary embodiment focused on an object at infinity.

FIG. 27 is a schematic diagram illustrating an image capturing apparatus.

### DESCRIPTION OF THE EMBODIMENTS

Various exemplary embodiments of the disclosure will be described below with reference to the attached drawings. The drawings may not be drawn to scale for convenience. The same reference numerals are assigned to the same members throughout the drawings to avoid repetition in descriptions.

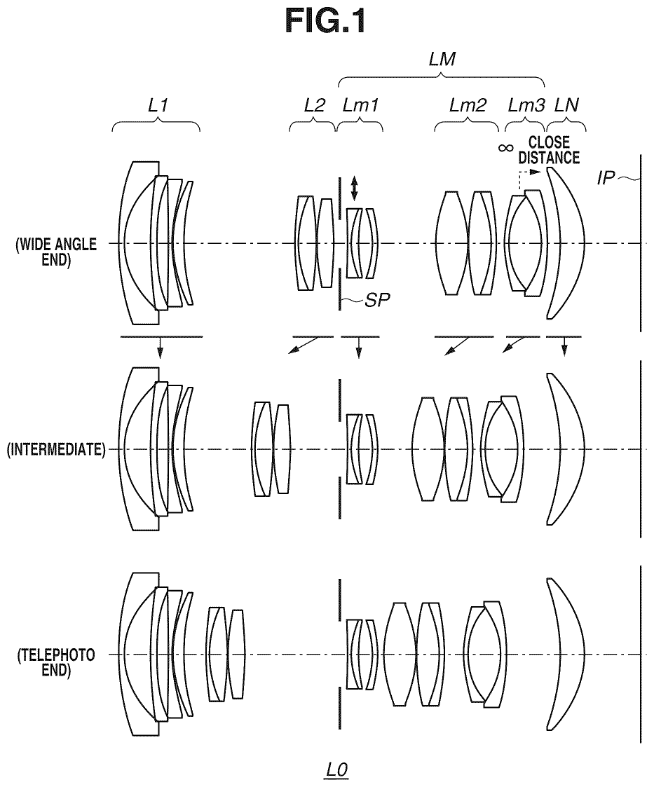

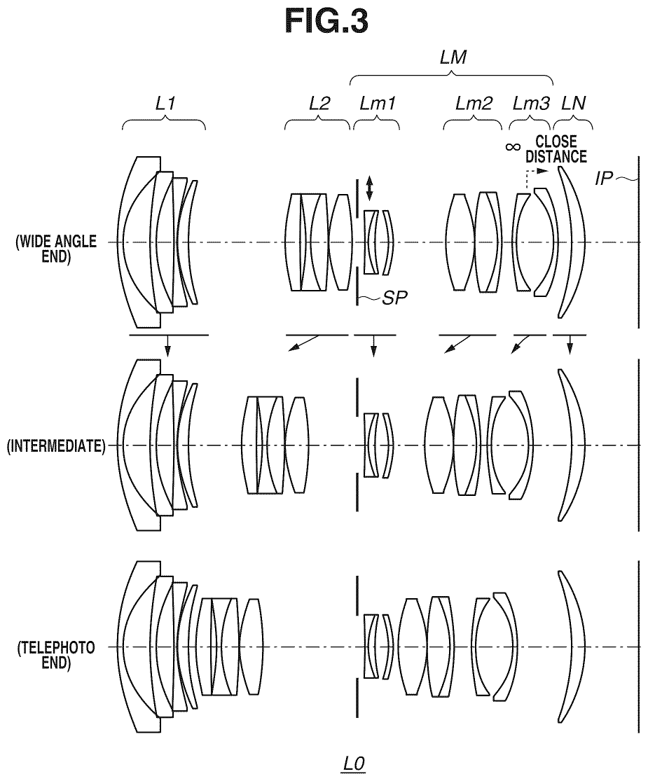

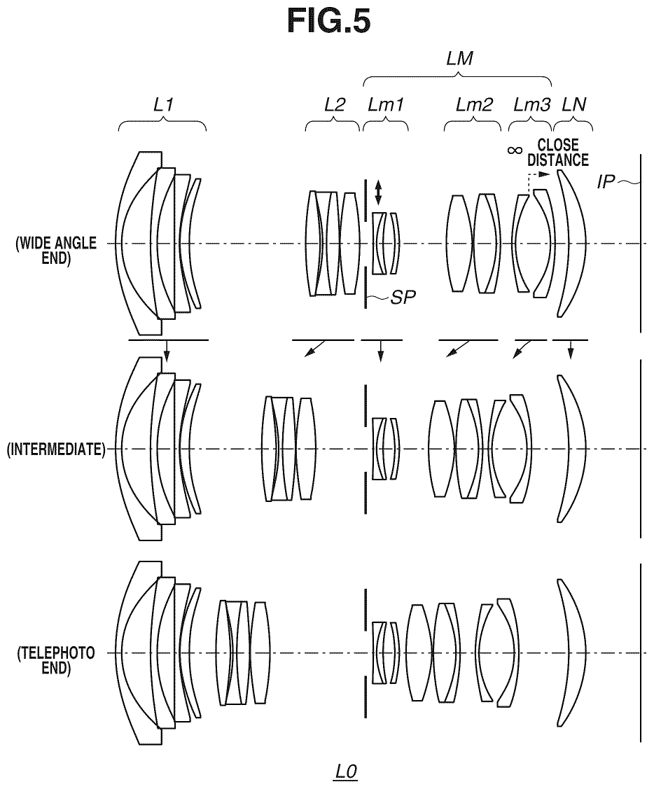

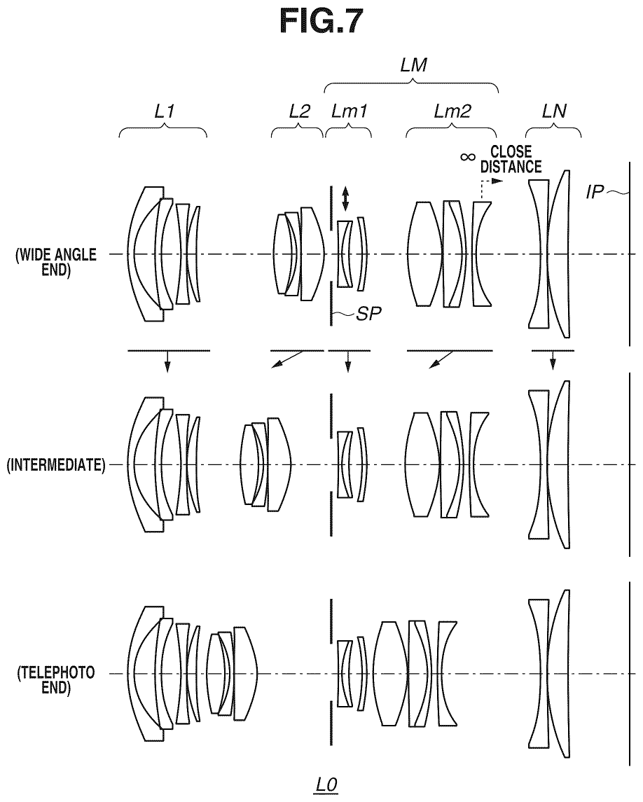

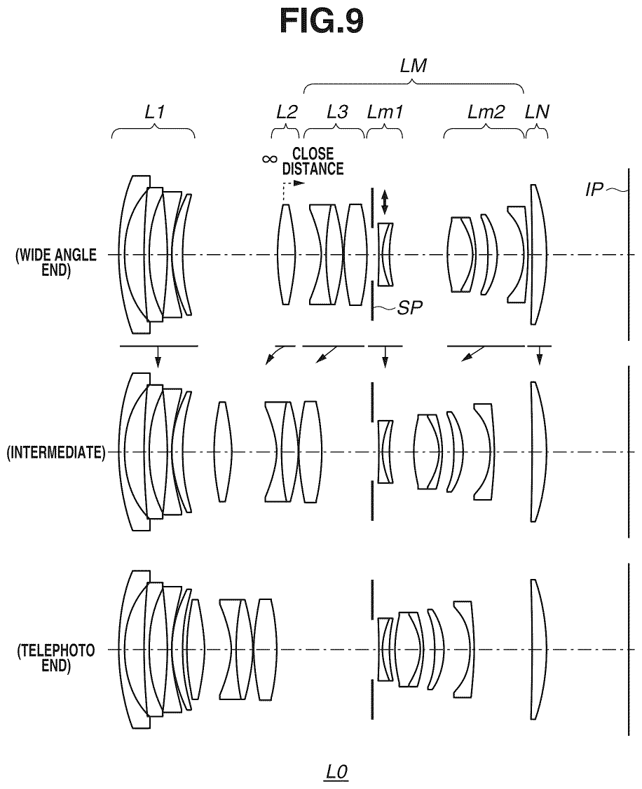

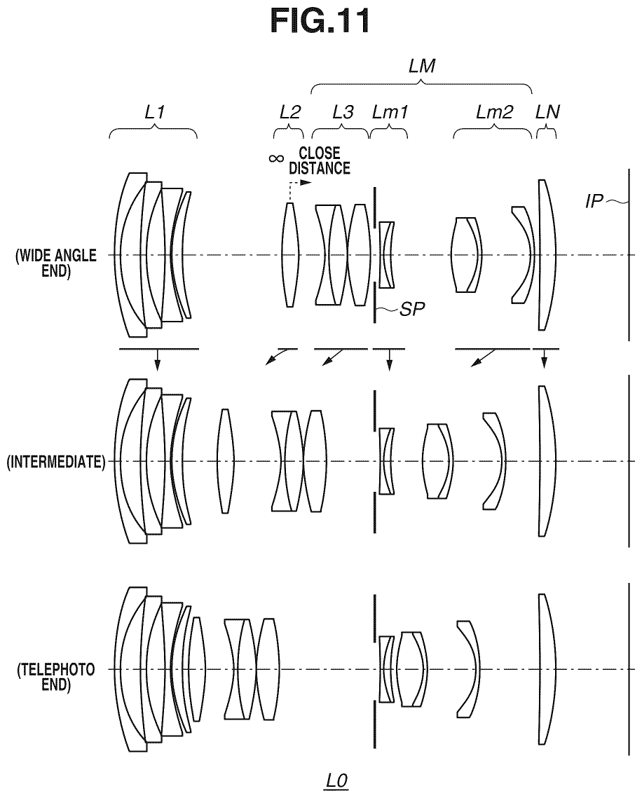

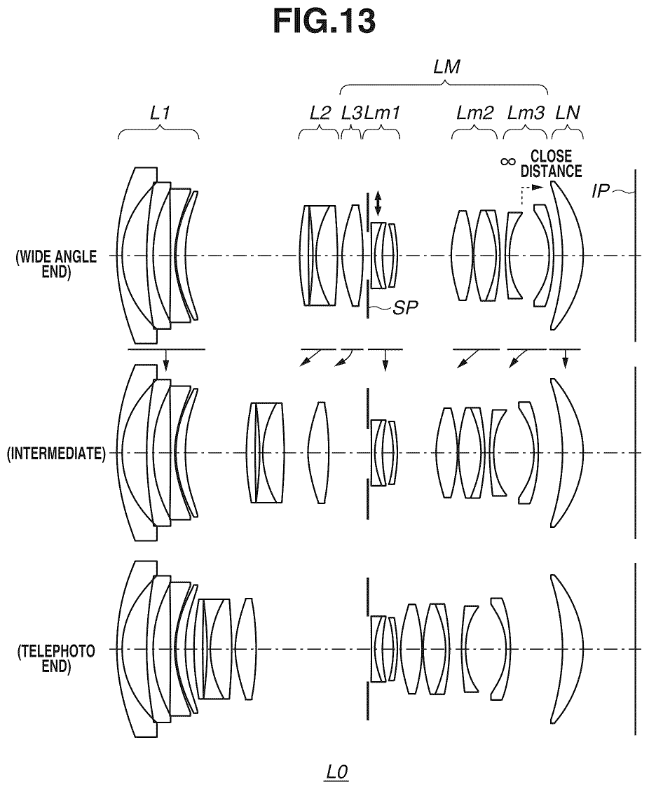

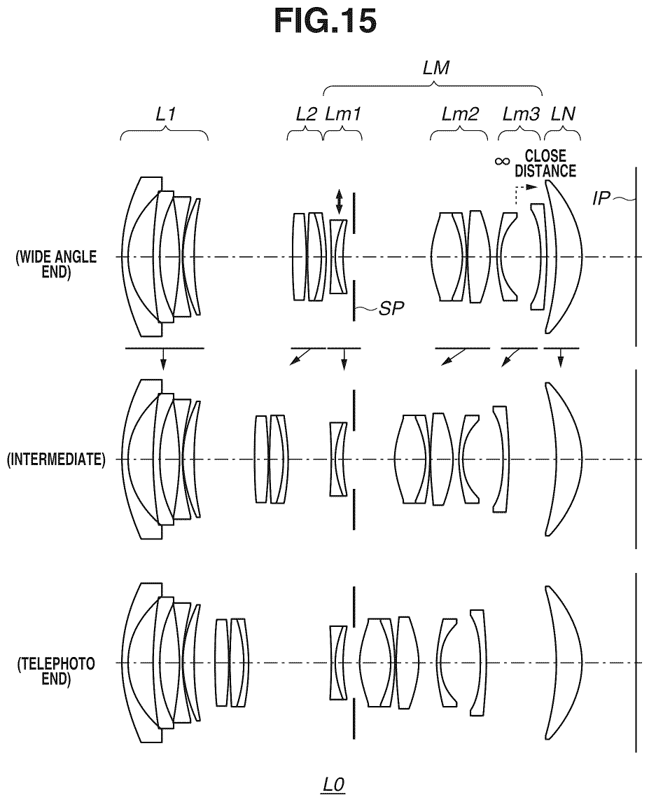

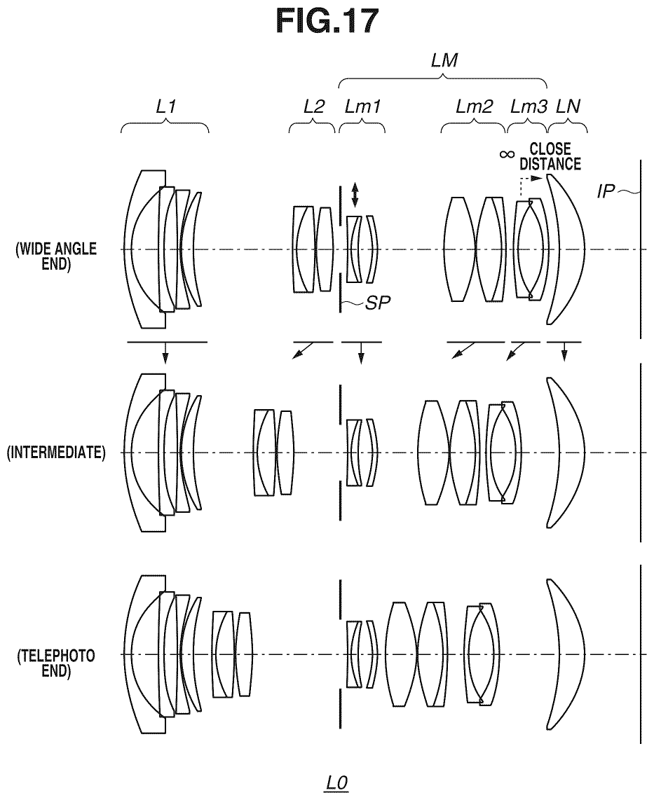

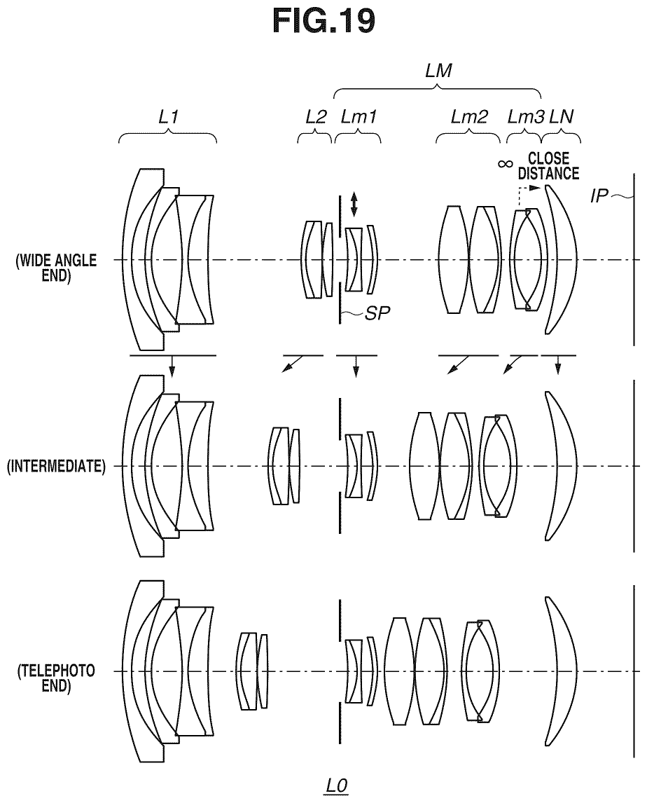

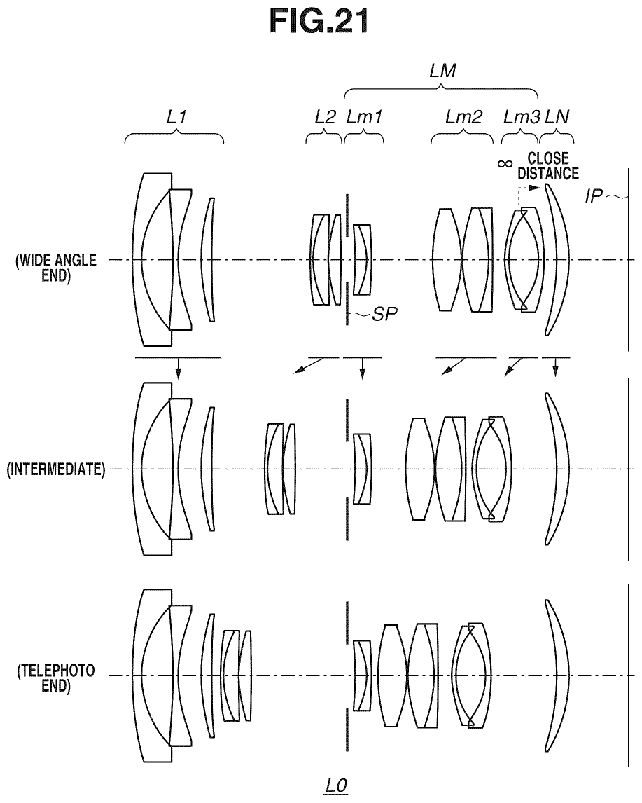

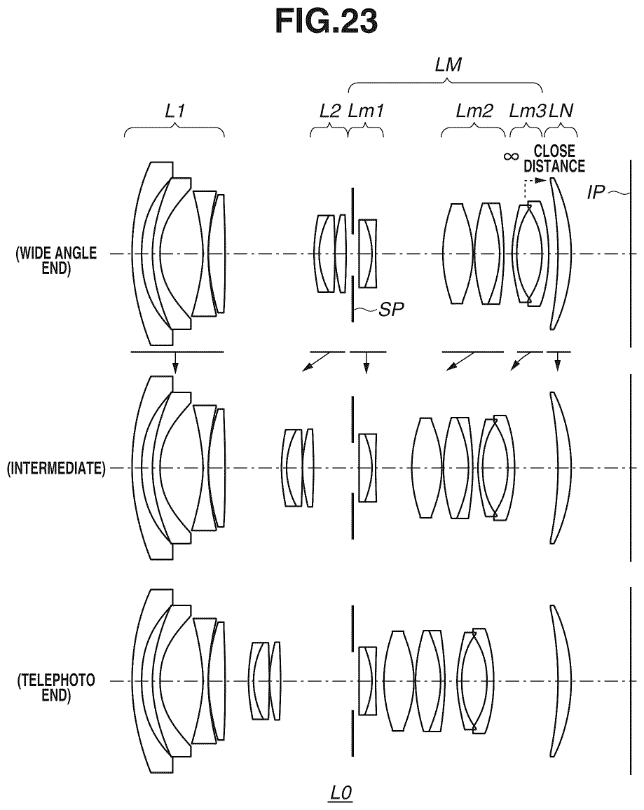

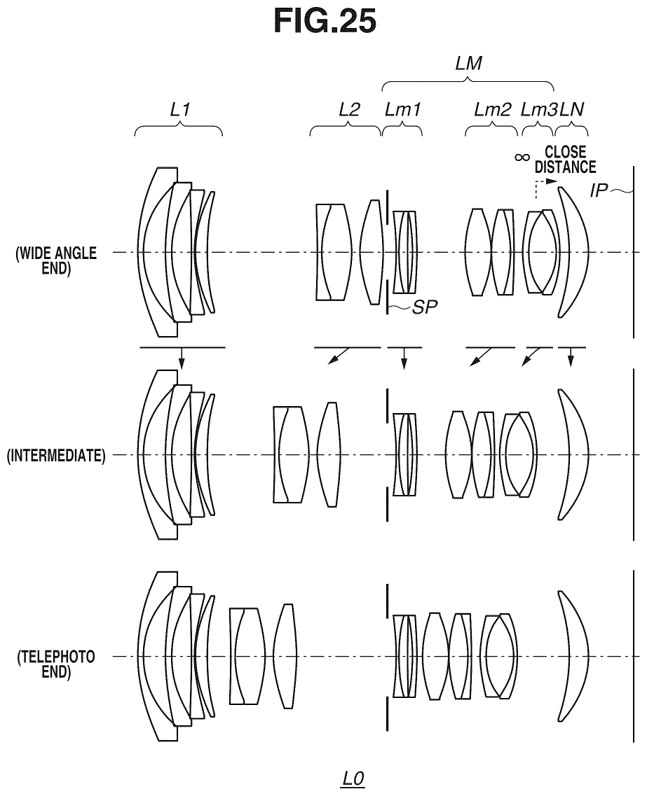

FIGS. 1, 3, 5, 7, 9, 11, 13, 15, 17, 19, 21, 23, and 25 are cross-sectional views of zoom lenses according to first to thirteenth exemplary embodiments, respectively. In each drawing, the left side is an object side (front side), and the right side is an image side (rear side). A zoom lens L0 according to each of the exemplary embodiments includes a plurality of lens units, and an interval between adjacent lens units changes during zooming. The lens units may include one lens or a plurality of lenses.

In each drawing, a lens unit Li is an i-th (i is a natural number) lens unit counted from the object side in the zoom lens L0. An intermediate unit LM includes one or more lens units, and a lens unit Lmi is the i-th (i is a natural number) lens unit included in the intermediate unit LM, counting from a lens unit including an image stabilization unit to the image side. A final lens unit LN is arranged closest to the image side.

Further, an aperture stop SP that determines a light flux of a maximum F-number (Fno) and an image plane IP are illustrated in each drawing. In a case where the zoom lens L0 according to each of the exemplary embodiments is used as an imaging optical system of a digital video camera or a digital still camera, an image capturing plane of a solid state imaging element (photoelectric conversion element) is arranged on the image plane IP. As the solid state imaging element, a charge coupled device (CCD) sensor or a complementary metal oxide semiconductor (CMOS) sensor can be used. In a case where the zoom lens L0 according to each of the exemplary embodiments is used as an imaging optical system of a silver halide film camera, a photosensitive surface of a film is arranged on the image plane IP.

The zoom lens according to each of the exemplary embodiments may be used as a projection lens of a projector or the like. In this case, the left side is the screen side, and the right side is the projected image side.

Each solid arrow in each drawing indicates a movement trajectory of each lens unit during zooming from the wide angle end to the telephoto end, and a solid arrow is drawn below the lens unit that moves in an optical axis direction during zooming. In addition, an image stabilization unit is moved as indicated by an arrow in a vertical direction in image blur correction.

Each dashed arrow in each drawing indicates the movement trajectory of each lens unit during focusing from an infinite distance to a close distance (closest end), and a dashed arrow is drawn above the lens unit that moves during focusing.

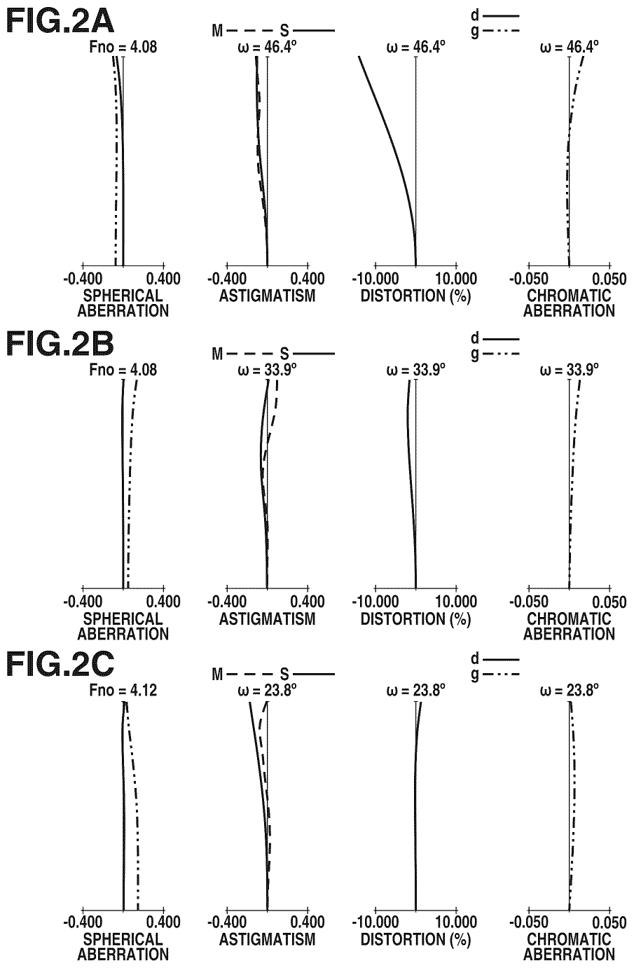

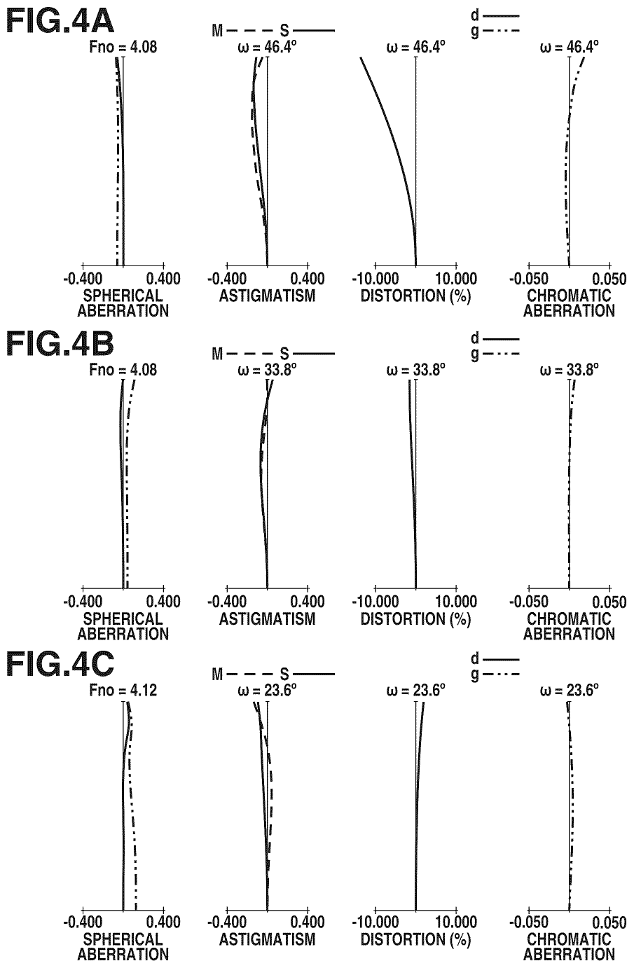

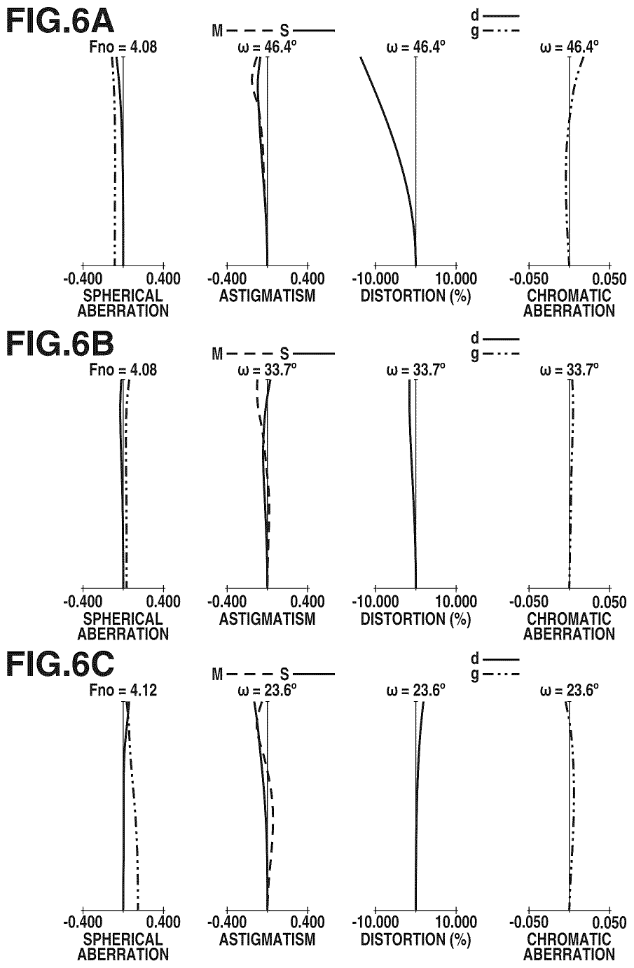

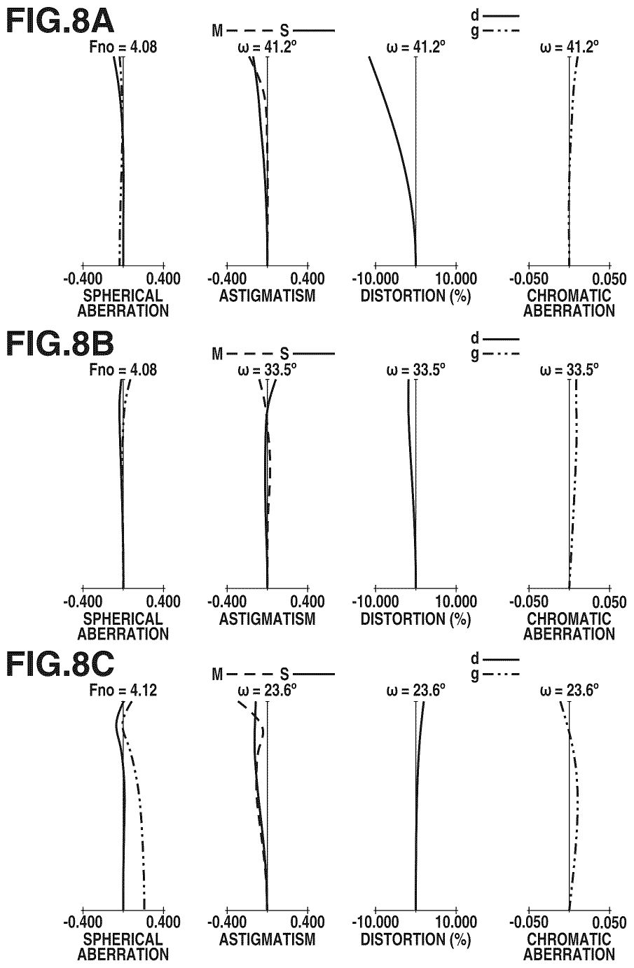

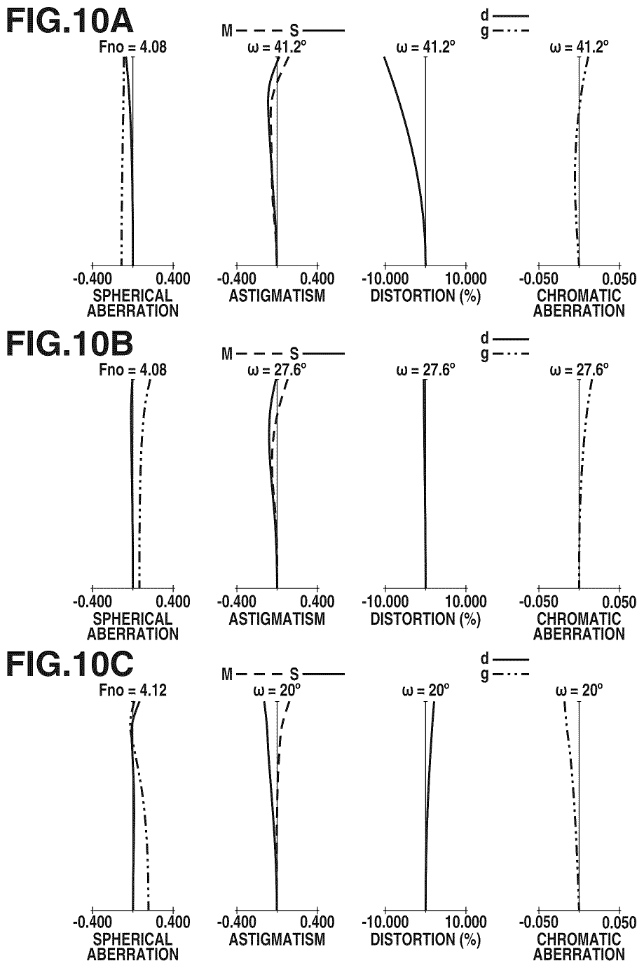

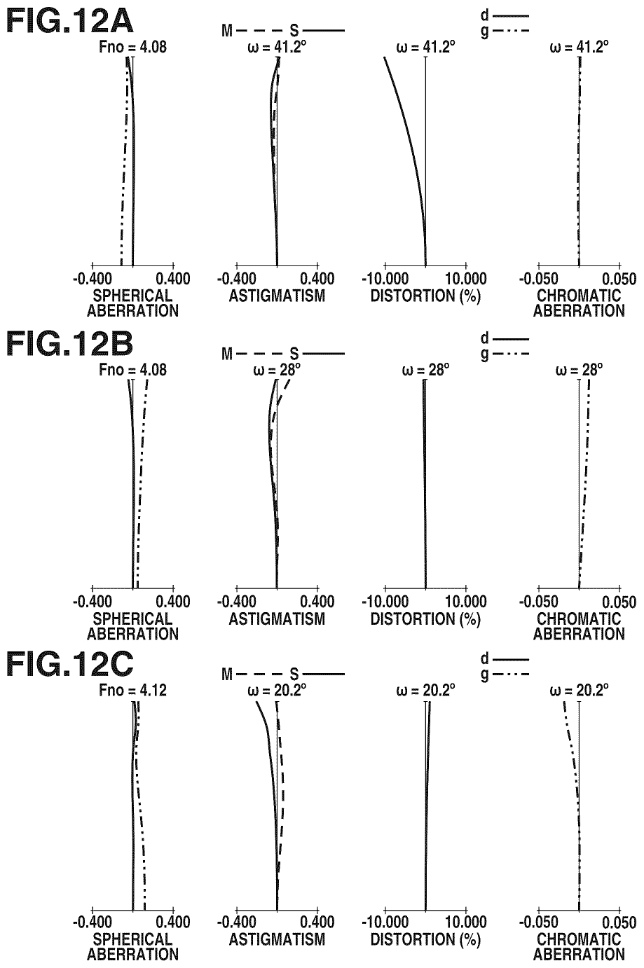

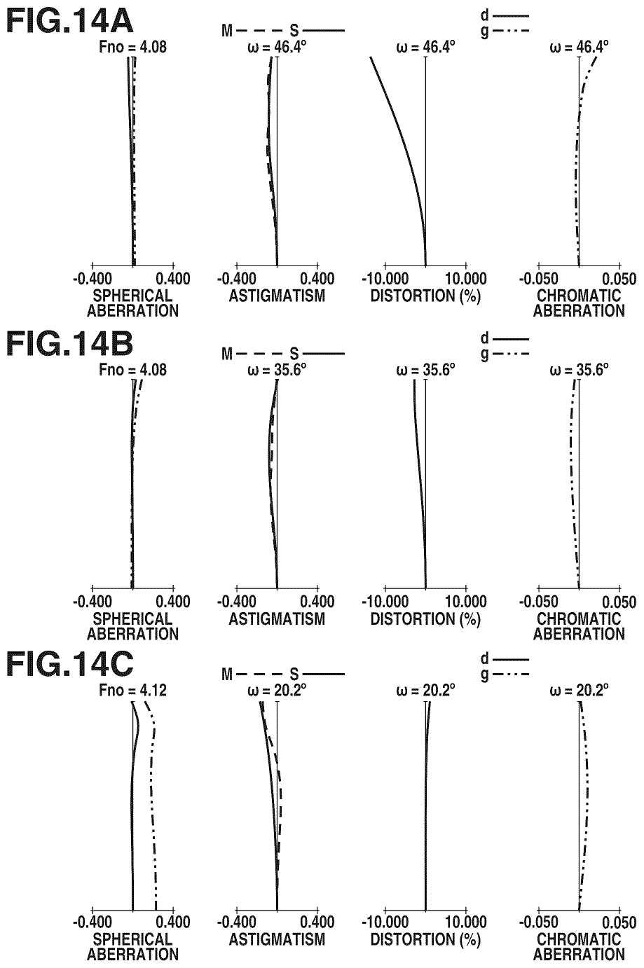

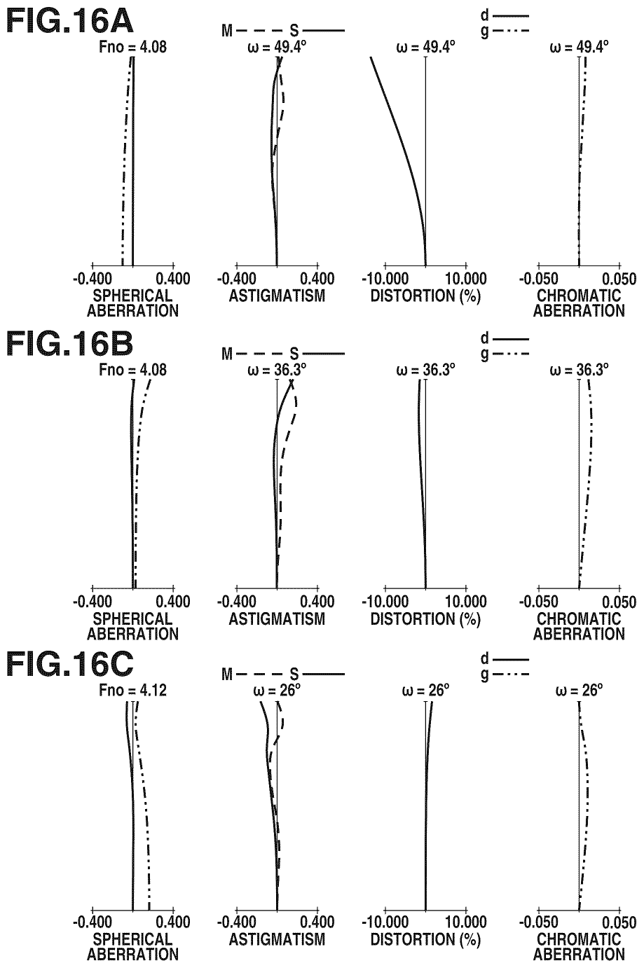

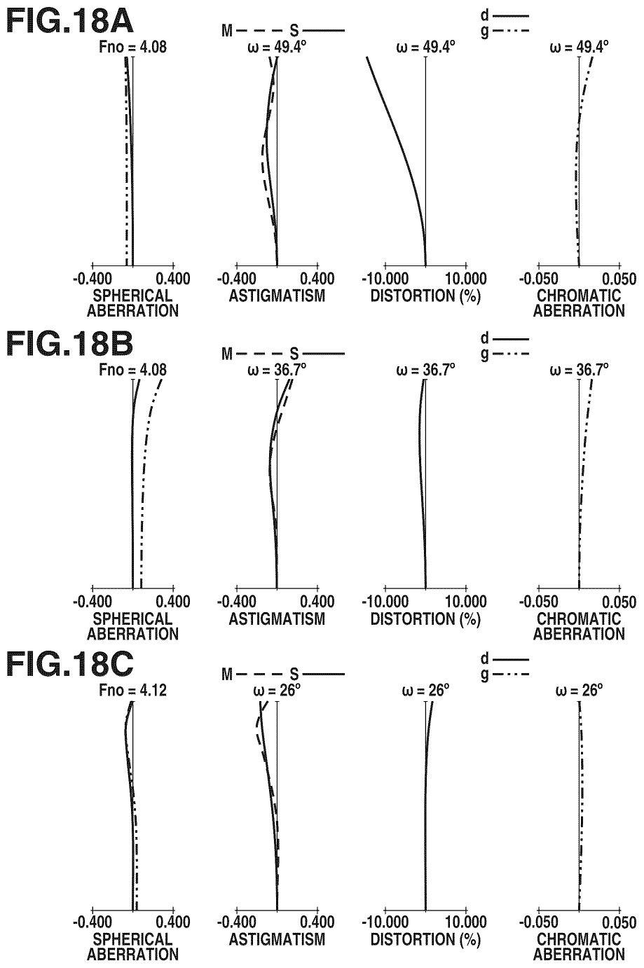

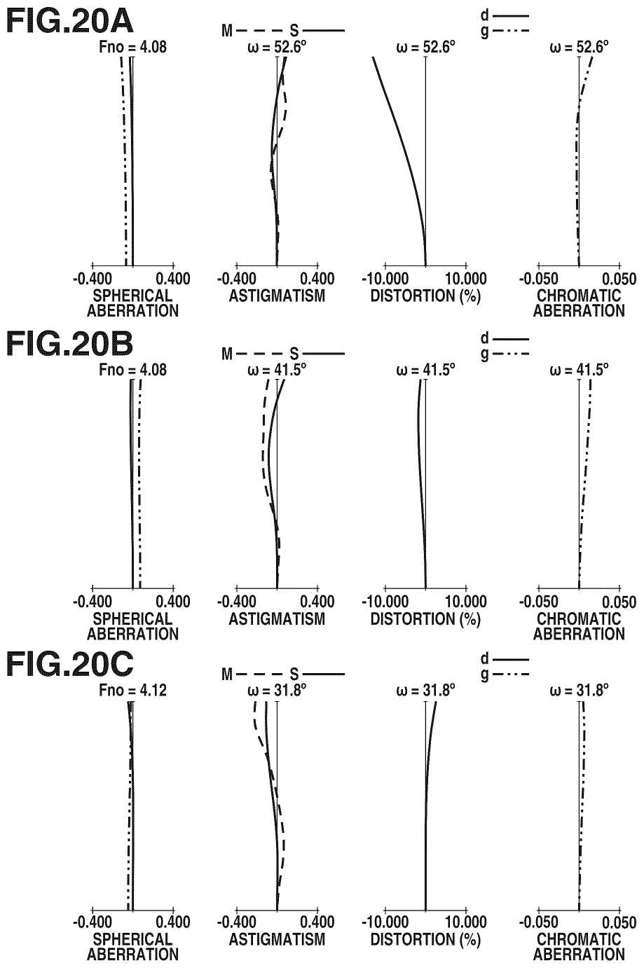

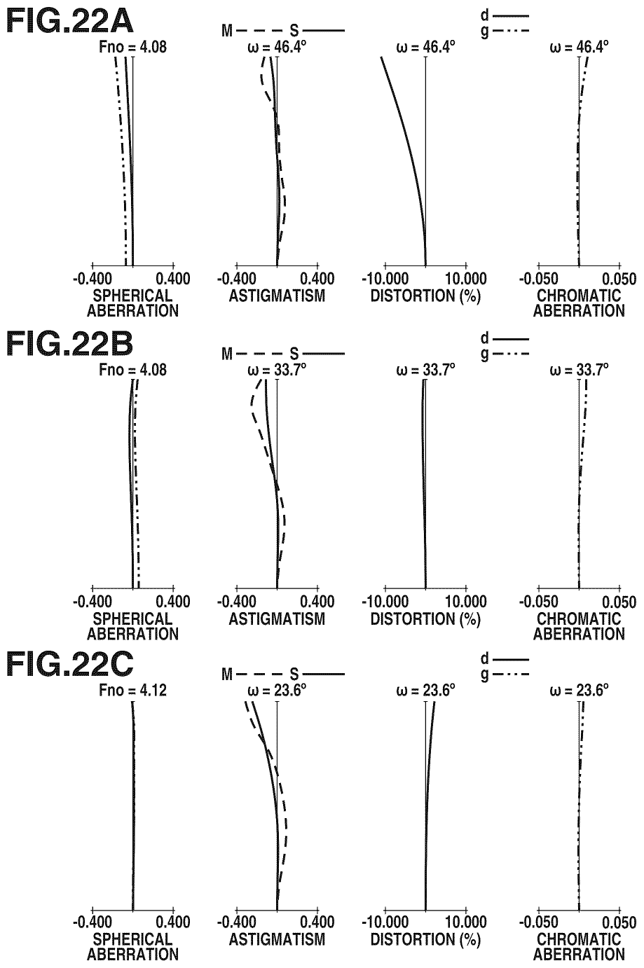

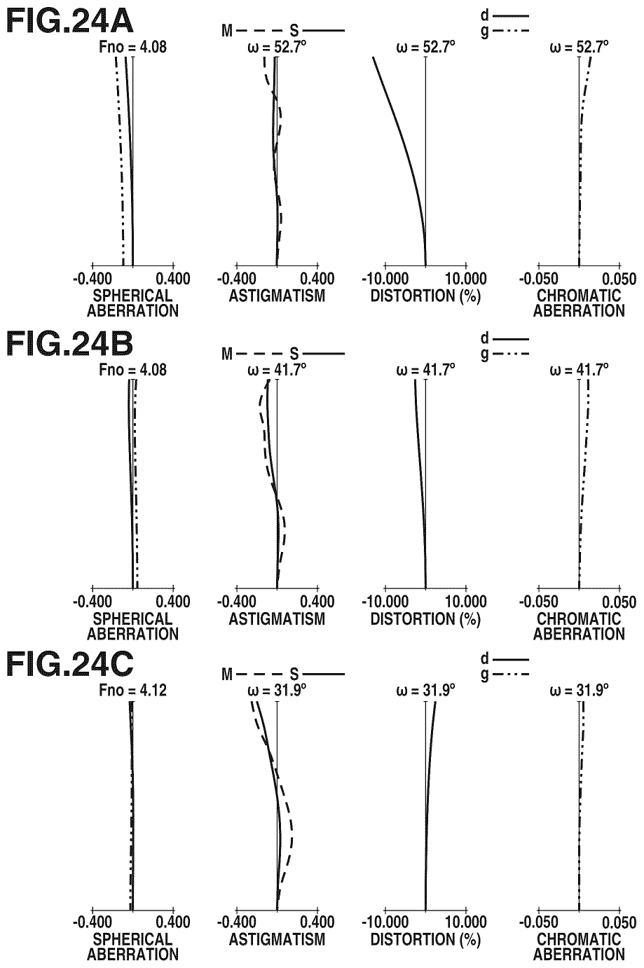

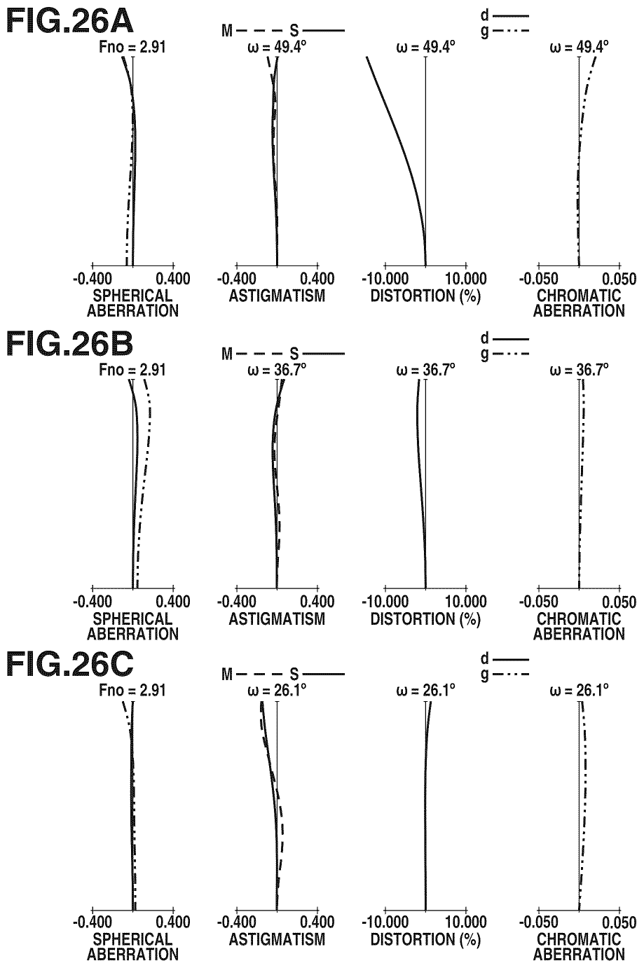

FIGS. 2, 4, 6, 8, 10, 12, 14, 16, 18, 20, 22, 24 and 26 are aberration diagrams at the wide angle end, the intermediate zoom position, and the telephoto end in a case where the zoom lenses according to the first to thirteenth exemplary embodiments are focused on an object at infinity, respectively.

In each drawing, Fno is an F-number, and ω is an imaging half angle of view (°) acquired by paraxial calculation. In a spherical aberration diagram, a solid line indicates a spherical aberration at a d-line (wavelength 587.56 nm), and an alternate long and two short dashed line indicates a spherical aberration at a g-line (wavelength 435.835 nm). In an astigmatism diagram, a solid line indicates astigmatism at the d-line on a sagittal image plane, and a dashed line indicates astigmatism at the d-line on a meridional image plane. A distortion diagram indicates a distortion at the d-line. A chromatic aberration diagram indicates a chromatic aberration of magnification at the g-line.

Next, a characteristic configuration of the zoom lens L0 according to each of the exemplary embodiments will be described.

The zoom lens L0 according to each of the exemplary embodiments includes a first lens unit L1 having negative refractive power, a second lens unit L2, the intermediate unit LM including one or more lens units, and the final lens unit LN, which are arranged in this order from the object side to the image side. The first lens unit L1 includes two or more lenses. The intermediate unit LM includes a first intermediate lens unit Lm1 and a second intermediate lens unit Lm2 arranged adjacent to the image side of the first intermediate lens unit Lm1. The first lens unit L1 and the first intermediate lens unit Lm1 do not move with respect to the image plane IP during zooming. The lenses included in the first lens unit L1 have large outer diameters and thus tend to be heavy. Accordingly, by not allowing the first lens unit L1 to move during zooming, quick and quiet zooming can be realized. Further, inclining of the first lens unit L1 that occurs during zooming can be prevented.

In the zoom lens L0 according to each of the exemplary embodiments, the first intermediate lens unit Lm1 does not move with respect to the image plane IP, and the second lens unit L2 and the second intermediate lens unit Lm2 move toward the object side during zooming from the wide angle end to the telephoto end. The second lens unit L2 and the second intermediate lens unit Lm2, which have positive refractive power, are moved toward the object side so that they respectively approach the first lens unit L1 and the first intermediate lens unit Lm1, which have negative refractive power, and accordingly a variable magnification function can be realized.

In addition, by arranging the first intermediate lens unit Lm1 that does not move during zooming, movement amounts of the second lens unit L2 and the second intermediate lens unit Lm2 can be reduced in achieving a high variable magnification ratio.

The zoom lens L0 according to each of the exemplary embodiments is configured to satisfy following inequalities.

Here, D1 is a distance on an optical axis from a surface vertex of a lens surface closest to the object side in the first lens unit L1 to a surface vertex of a lens surface closest to the image side in the first lens unit L1. TLw is a distance on the optical axis at the wide angle end from the surface vertex of the lens surface closest to the object side in the zoom lens L0 to the surface vertex of the lens surface closest to the image side in the zoom lens L0. Skw is an air equivalent distance on the optical axis at the wide angle end from the surface vertex of the lens surface closest to the image side in the zoom lens L0 to the image plane, and fw is a focal length of an overall system of the zoom lens L0 at the wide angle end. Further, ft is the focal length of the overall system of the zoom lens L0 at the telephoto end, and vdn is the largest Abbe number among Abbe numbers of materials of negative lenses included in the first lens unit L1.

$$0.04 < D 1 / TLw < 0.25 \qquad ( 1 )$$

$$0.05 < Skw / fw < 1.5 \qquad ( 2 )$$

$$1.65 < ft / fw < 6. \qquad ( 3 )$$

$$vdn > 50 \qquad ( 4 )$$

Inequality (1) defines a thickness of the first lens unit L1 with respect to an overall length of the zoom lens L0. If a value exceeds an upper limit value of the inequality (1), the first lens unit L1 becomes too large.

Accordingly, it is not desirable because a sufficient space cannot be secured for a movable unit to ensure a movement amount for achieving the high variable magnification ratio. On the other hand, if a value is below a lower limit value of the inequality (1), it is not desirable because it is not possible to arrange a lens necessary to satisfactorily correct various aberrations occurring in the first lens unit L1 or the overall length of the zoom lens L0 becomes too large.

Inequality (2) defines a ratio between a back focus and a focal length of the zoom lens L0 at the wide angle end. If a value exceeds an upper limit value of the inequality (2), it is not desirable because an overall optical length becomes too large. On the other hand, if a value is below a lower limit value of the inequality (2), it is not desirable because a flange back cannot be sufficiently secured, which makes it difficult to arrange a shutter member and the like.

Inequality (3) defines a variable magnification ratio of the zoom lens L0. If a value exceeds an upper limit value of the inequality (3), the variable magnification ratio becomes too large. Accordingly, it is not desirable because it becomes difficult to suppress a zoom variation in optical performance across an entire zoom range. On the other hand, if a value is below a lower limit value of the inequality (3), it is not desirable because it becomes difficult to achieve a sufficient high variable magnification ratio.

Inequality (4) defines dispersion of a material of one negative lens in the first lens unit. If a value is below a lower limit value of the inequality (4), dispersion of the negative lens becomes too large. Accordingly, it is not desirable because it becomes difficult to achieve primary achromatization and secondary achromatization of magnification chromatic aberration at the wide angle end.

With the above-described configuration, it is possible to provide a zoom lens that has a high variable magnification ratio and high optical performance and can be equipped with an electric zoom function.

Further, in one embodiment, numerical value ranges of the inequalities (1) to (4) are set to numerical value ranges of following inequalities (1a) to (4a).

$$0.08 < D 1 / TLw < 0.23 \qquad ( 1 a )$$

$$0.2 < Skw / fw < 1.3 \qquad ( 2 a )$$

$$1.75 < ft / fw < 5. \qquad ( 3 a )$$

$$vdn > 60 \qquad ( 4 a )$$

Further, in another embodiment, the numerical value ranges of the inequalities (1) to (4) are set to numerical value ranges of following inequalities (1b) to (4b).

$$0.1 < D 1 / TLw < 0.22 \qquad ( 1 b )$$

$$0.3 < Skw / fw < 1.1 \qquad ( 2 b )$$

$$1.8 < ft / fw < 4. \qquad ( 3 b )$$

$$vdn > 65 \qquad ( 4 b )$$

Next, conditions that the zoom lens L0 according to each of the exemplary embodiments satisfies are described.

In one embodiment, the final lens unit LN does not move with respect to the image plane IP. The lenses included in the final lens unit LN have large outer diameters and tend to be heavy. By not allowing the final lens unit LN to move during zooming, quick and quiet zooming can be realized.

In one embodiment, the first intermediate lens unit Lm1 has the aperture stop SP. With this configuration, it is possible to reduce size and weight of a movable unit, such as the second lens unit L2 and the second intermediate lens unit Lm2, which are arranged near the aperture stop SP. Accordingly, it is possible to achieve good optical performance over an entire zoom range with high variable magnification ratio while reducing a load on an actuator that electrically moves the lens unit during zooming. In order to more effectively suppress zoom variations, such as spherical aberration and field curvature, a lens unit that moves toward the object side during zooming from the wide angle end to the telephoto end may be arranged on the image side of the second lens unit L2 and the second intermediate lens unit Lm2.

In one embodiment, the first lens unit L1 includes a lens having negative refractive power and a lens having positive refractive power. With this configuration, various aberrations, such as the chromatic aberration and the field curvature, which occur in the first lens unit L1 can be satisfactorily corrected.

In one embodiment, a positive lens in the first lens unit L1 is arranged closest to the image side in the first lens unit L1. With this configuration, the chromatic aberration occurring in the first lens unit L1 can be satisfactorily corrected. Further, a lens arranged closest to the object side in the first lens unit L1 is a negative meniscus lens with a convex surface facing the object side. With this configuration, the zoom lens L0 can have a wide angle while satisfactorily correcting an off-axis aberration.

In one embodiment, the second intermediate lens unit Lm2 includes a lens having an aspherical lens surface. With this configuration, it is possible to satisfactorily correct the off-axis aberration occurring at the wide angle end while reducing the overall length of the zoom lens L0.

In one embodiment, a focusing unit that moves during focusing is configured with the movable unit or a part thereof that is arranged adjacent on the image side of the first lens unit L1 or adjacent on the object side of the final lens unit LN. By using the movable unit, which is small and lightweight, a load on the actuator can be reduced, and quick and quiet focusing can be realized.

In one embodiment, the lens unit having negative refractive power is arranged on the image side of the second intermediate lens unit Lm2. With this configuration, the second intermediate lens unit Lm2 having positive refractive power and the lens unit having negative refractive power are arranged side by side in a telephoto type configuration, so that the overall length of the zoom lens L0 can be shortened. Particularly, in the zoom lens L0 according to the first to third and seventh to thirteenth exemplary embodiments described below, a third intermediate lens unit Lm3 having negative refractive power is arranged on the image side of the second intermediate lens unit Lm2. With this configuration, the overall length of the zoom lens L0 can be shortened. Further, during zooming from the wide angle end to the telephoto end, the third intermediate lens unit Lm3 moves toward the object side while changing an interval between it and the second intermediate lens unit Lm2, so that the zoom variation such as the field curvature can be satisfactorily corrected.

In one embodiment, the first intermediate lens unit Lm1 includes the image stabilization unit. The image stabilization unit is a mechanism that reduces blur in a captured image by moving so as to include a component in a direction perpendicular to the optical axis during image blur correction. The image stabilization unit includes, for example, a cemented lens of one negative lens and one positive lens and can suppress a fluctuation in chromatic aberration during image blur correction. The image stabilization unit can be arranged adjacent to the aperture stop SP, so that it is possible to reduce a weight of the image stabilization unit that moves for image blur correction. Further, the image stabilization unit is mounted on a lens unit that does not move with respect to the image plane IP during zooming, and thus an image stabilization function can be provided without increasing a weight of the movable unit such as the second lens unit L2 and the second intermediate lens unit Lm2.

The zoom lens L0 according to each of the exemplary embodiments satisfies at least one of following inequalities (5) to (14).

Here, Da is a maximum air gap among air gaps on the optical axis in the first lens unit L1. Further, f1 is a focal length of the first lens unit L1, fm1 is a focal length of the first intermediate lens unit Lm1, fm2 is a focal length of the second intermediate lens unit Lm2, and fm3 is a focal length of the third intermediate lens unit Lm3.

Further, fa_t is a combined focal length at the telephoto end of lenses arranged between the first lens unit L1 and the first intermediate lens unit Lm1. Furthermore, xa_t is a distance on the optical axis at the telephoto end from a surface vertex of a lens surface closest to the object side among the lenses arranged between the first lens unit L1 and the first intermediate lens unit Lm1 to a surface vertex of a lens surface closest to the object side of the first intermediate lens unit Lm1. In addition, xb_w is a distance on the optical axis at the wide angle end from a surface vertex of a lens surface closest to the image side of the first intermediate lens unit Lm1 to a surface vertex of a lens surface closest to the image side among lenses arranged between the first intermediate lens unit Lm1 and the final lens unit LN.

Further, ma is a largest movement amount of the lens unit arranged between the first lens unit L1 and the first intermediate lens unit Lm1 during zooming from the wide angle end to the telephoto end.

Further, mb is a largest movement amount of the lens unit arranged between the first intermediate lens unit Lm1 and the final lens unit LN during zooming from the wide angle end to the telephoto end. Here, the movement amount of the lens unit corresponds to a difference between a position at the wide angle end and a position at the telephoto end on the optical axis. A sign of the movement amount is positive if it is located closer to the image side at the telephoto end than at the wide angle end.

$$0.1 < Da / D 1 < 0.6 \qquad ( 5 )$$

$$0.48 < ( - f 1 ) / fa\_t < 1.27 \qquad ( 6 )$$

$$0.25 < f 1 / fm 1 < 0.88 \qquad ( 7 )$$

$$0.83 < ( - f 1 ) / fw < 1.97 \qquad ( 8 )$$

$$0.38 < fa\_t / ft < 1.51 \qquad ( 9 )$$

$$0.2 < xa\_t / TLw < 0.56 \qquad ( 10 )$$

$$0.19 < xb\_w / TLw < 0.55 \qquad ( 11 )$$

$$0.09 < \vert ma \vert / TLw < 0.27 \qquad ( 12 )$$

$$0.06 < \vert mb \vert / TLw < 0.2 \qquad ( 13 )$$

$$0.71 < fm 2 / ( - fm 3 ) < 1.36 \qquad ( 14 )$$

Technical meaning of each inequality will be described below.

Inequality (5) defines a ratio of the thickness of the first lens unit L1 with respect to the maximum air gap within the first lens unit L1. If a value exceeds an upper limit value of the inequality (5), the first lens unit L1 becomes too large. Accordingly, it is not desirable because a size of the zoom lens L0 is increased. On the other hand, if a value is below a lower limit value of the inequality (5), it is not desirable because a sufficient distance cannot be secured for arranging a lens necessary for satisfactorily correcting various aberrations occurring in the first lens unit L1.

Inequality (6) defines a ratio between the focal length of the first lens unit L1 and the combined focal length of the lenses arranged between the first lens unit L1 and the first intermediate lens unit Lm1. If a value exceeds an upper limit value of the inequality (6), the power of the lens unit arranged between the first lens unit L1 and the first intermediate lens unit Lm1 becomes too strong. Accordingly, it is not desirable because it becomes difficult to satisfactorily correct various aberrations such as the spherical aberration. On the other hand, if a value is below a lower limit value of the inequality (6), it is not desirable because the power of the first lens unit L1 becomes too strong, which makes it difficult to satisfactorily correct various aberrations such as the field curvature.

Inequality (7) defines a ratio between and the focal length of the first lens unit L1 and the focal length of the first intermediate lens unit Lm1. If a value exceeds an upper limit value of the inequality (7), it is not desirable because the power of the first intermediate lens unit Lm1 becomes too strong, which makes it difficult to satisfactorily correct various aberrations such as the spherical aberration. On the other hand, if a value is below a lower limit value of the inequality (7), it is not desirable because the power of the first intermediate lens unit Lm1 becomes too weak, which makes it difficult to achieve a sufficient high variable magnification ratio.

Inequality (8) defines a ratio between the focal length of the first lens unit L1 and the focal length of the entire zoom lens L0 at the wide angle end. If a value exceeds an upper limit value of the inequality (8), the power of the first lens unit L1 becomes too weak. Accordingly, it is not desirable because a front lens becomes larger and the zoom lens L0 becomes larger in widening the angle. On the other hand, if a value is below a lower limit value of the inequality (8), the power of the first lens unit L1 becomes too strong. Accordingly, it is not desirable because it becomes difficult to satisfactorily correct various aberrations occurring in the first lens unit L1 in widening the angle.

Inequality (9) defines a ratio between the combined focal length of the lenses arranged between the first lens unit L1 and the first intermediate lens unit Lm1 and the focal length of the entire zoom lens L0 at the telephoto end. If a value exceeds an upper limit value of the inequality (9), it is not desirable because the power of the lens unit arranged between the first lens unit L1 and the first intermediate lens unit Lm1 becomes too weak, which increases the movement amount necessary for variable magnification. On the other hand, if a value is below a lower limit value of the inequality (9), the power of the lens unit arranged between the first lens unit L1 and the first intermediate lens unit Lm1 becomes too strong. Accordingly, it is not desirable because it becomes difficult to satisfactorily correct various aberrations such as the spherical aberration.

Inequality (10) defines a distance on the optical axis at the telephoto end from a surface vertex of a lens surface closest to the object side in the movable unit arranged on the object side of the first intermediate lens unit Lm1 to the surface vertex of the lens surface closest to the object side of the first intermediate lens unit Lm1 with respect to the overall length of the lens. If a value exceeds an upper limit value of the inequality (10), it is not desirable because the movable unit that is arranged closer to the object side than the first intermediate lens unit Lm1 becomes larger in order to take in off-axis light at the telephoto end. On the other hand, if a value is below a lower limit value of the inequality (10), it is not desirable because the sufficient space cannot be secured for the movable unit to ensure the movement amount for achieving the high variable magnification ratio.

Inequality (11) defines a distance on the optical axis at the wide angle end from the surface vertex of the lens surface closest to the image side in the first intermediate lens unit Lm1 to the surface vertex of the lens surface closest to the image side in the movable unit arranged closer to the image side than the first intermediate lens unit Lm1 with respect to the overall length of the lens. If a value exceeds an upper limit value of the inequality (11), it is not desirable because the movable unit that is arranged closer to the image side than the first intermediate lens unit Lm1 becomes larger in order to take in the off-axis light at the wide angle end. On the other hand, if a value is below a lower limit value of the inequality (11), it is not desirable because the sufficient space cannot be secured for the movable unit to ensure the movement amount for achieving the high variable magnification ratio.

Inequality (12) defines the movement amount of the movable unit arranged closer to the object side than the first intermediate lens unit Lm1 with respect to the overall length of the lens. If a value exceeds an upper limit value of the inequality (12), it is not desirable because the movement amount becomes too large. On the other hand, if a value is below a lower limit value of the inequality (12), it is not desirable because the movement amount becomes too small, which makes it difficult to achieve sufficient high variable magnification ratio.

Inequality (13) defines the movement amount of the movable unit arranged closer to the image side than the first intermediate lens unit Lm1 with respect to the overall length of the lens. If a value exceeds an upper limit value of the inequality (13), it is not desirable because the movement amount becomes too large. On the other hand, if a value is below a lower limit value of the inequality (13), it is not desirable because the movement amount becomes too small, which makes it difficult to achieve sufficient high variable magnification ratio.

Inequality (14) defines a ratio between the focal length of the second intermediate lens unit Lm2 and the focal length of the third intermediate lens unit Lm3. If a value exceeds an upper limit value of the inequality (14), it is not desirable because the power of the third intermediate lens unit Lm3 becomes too strong, which makes it difficult to satisfactorily correct various aberrations such as the field curvature. On the other hand, if a value is below a lower limit value of the inequality (14), it is not desirable because the power of the second intermediate lens unit Lm2 becomes too strong. Accordingly, it is not desirable because it becomes difficult to satisfactorily correct various aberrations such as the spherical aberration at the telephoto end and various aberrations such as the field curvature at the wide angle end.

In one embodiment, numerical value ranges of the inequalities (5) to (14) are set to numerical value ranges of following inequalities (5a) to (14a).

$$0.15 < Da / D 1 < 0.55 \qquad ( 5 a )$$

$$0.54 < ( - f 1 ) / fa\_t < 1.17 \qquad ( 6 a )$$

$$0.27 < f 1 / fm 1 < 0.82 \qquad ( 7 a )$$

$$0.94 < ( - f 1 ) / fw < 1.88 \qquad ( 8 a )$$

$$0.43 < fa\_t / ft < 1.3 \qquad ( 9 a )$$

$$0.21 < xa\_t / TLw < 0.52 \qquad ( 10 a )$$

$$0.22 < xb\_w / TLw < 0.51 \qquad ( 11 a )$$

$$0.11 < \vert ma \vert / TLw < 0.25 \qquad ( 12 a )$$

$$0.06 < \vert mb \vert / TLw < 0.18 \qquad ( 13 a )$$

$$0.75 < fm 2 / ( - fm 3 ) < 1.3 \qquad ( 14 a )$$

Further, in another embodiment, the numerical value ranges of the inequalities (5) to (14) are set to numerical value ranges of following inequalities (5b) to (14b).

$$0.2 < Da / D 1 < 0.5 \qquad ( 5 b )$$

$$0.57 < ( - f 1 ) / fa\_t < 1.08 \qquad ( 6 b )$$

$$0.28 < f 1 / fm 1 < 0.75 \qquad ( 7 b )$$

$$0.99 < ( - f 1 ) / fw < 1.8 \qquad ( 8 b )$$

$$0.46 < fa\_t / ft < 1.25 \qquad ( 9 b )$$

$$0.22 < xa\_t / TLw < 0.49 \qquad ( 10 b )$$

$$0.23 < xb\_w / TLw < 0.49 \qquad ( 11 b )$$

$$0.13 < \vert ma \vert / TLw < 0.24 \qquad ( 12 b )$$

$$0.07 < \vert mb \vert / TLw < 0.17 \qquad ( 13 b )$$

$$0.79 < fm 2 / ( - fm 3 ) < 1.25 \qquad ( 14 b )$$

Next, a detailed configuration of the zoom lens according to each of the exemplary embodiments will be described.

The zoom lens L0 according to a first exemplary embodiment consists of the first lens unit L1 having negative refractive power, the second lens unit L2 having positive refractive power, the intermediate unit LM, and the final lens unit LN having positive refractive power, which are arranged in this order from the object side to the image side. Further, the intermediate unit LM consists of the first intermediate lens unit Lm1 having negative refractive power, the second intermediate lens unit Lm2 having positive refractive power, and the third intermediate lens unit Lm3 having negative refractive power, which are arranged in this order from the object side to the image side.

The first lens unit L1, the first intermediate lens unit Lm1, and the final lens unit LN do not move with respect to the image plane IP during zooming. During zooming from the wide angle end to the telephoto end, the second lens unit L2 and the second intermediate lens unit Lm2 move monotonously toward the object side.

During zooming from the wide angle end to an intermediate zoom position, the third intermediate lens unit Lm3 moves monotonously toward the object side while narrowing down an interval between the third intermediate lens unit Lm3 and the second intermediate lens unit Lm2. During zooming from the intermediate zoom position to the telephoto end, the third intermediate lens unit Lm3 moves monotonously toward the object side while widening the interval between the third intermediate lens unit Lm3 and the second intermediate lens unit Lm2.

During focusing from an infinite distance to a close distance, the third intermediate lens unit Lm3 moves toward the image side.

The zoom lens L0 according to a second exemplary embodiment has a configuration similar to that of the zoom lens L0 according to the first exemplary embodiment.

The zoom lens L0 according to a third exemplary embodiment has a configuration similar to that of the zoom lens L0 according to the first exemplary embodiment.

The zoom lens L0 according to a fourth exemplary embodiment consists of the first lens unit L1 having negative refractive power, the second lens unit L2 having positive refractive power, the intermediate unit LM, and the final lens unit LN having negative refractive power, which are arranged in this order from the object side to the image side. The intermediate unit LM consists of the first intermediate lens unit Lm1 having negative refractive power and the second intermediate lens unit Lm2 having positive refractive power, which are arranged in this order from the object side to the image side.

The first lens unit L1, the first intermediate lens unit Lm1, and the final lens unit LN do not move with respect to the image plane IP during zooming. During zooming from the wide angle end to the telephoto end, the second lens unit L2 and the second intermediate lens unit Lm2 move monotonously toward the object side.

During focusing from the infinite distance to the close distance, the negative lens arranged closest to the image side in the second intermediate lens unit Lm2 moves toward the image side.

The zoom lens L0 according to a fifth exemplary embodiment includes the first lens unit L1 having negative refractive power, the second lens unit L2 having positive refractive power, the intermediate unit LM, and the final lens unit LN having positive refractive power, which are arranged in this order from the object side to the image side. The intermediate unit LM includes a third lens unit L3 having positive refractive power, the first intermediate lens unit Lm1 having negative refractive power, and the second intermediate lens unit Lm2 having positive refractive power, which are arranged in this order from the object side to the image side.

The first lens unit L1, the first intermediate lens unit Lm1, and the final lens unit LN do not move with respect to the image plane IP during zooming. During zooming from the wide angle end to the telephoto end, the second lens unit L2 and the second intermediate lens unit Lm2 move monotonously toward the object side.

During zooming from the wide angle end to the intermediate zoom position, the third lens unit L3 moves monotonously toward the object side while widening an interval between the third lens unit L3 and the second lens unit L2. During zooming from the intermediate zoom position to the telephoto end, the third lens unit L3 moves monotonously toward the object side while narrowing down the interval between the third lens unit L3 and the second lens unit L2.

During focusing from the infinite distance to the close distance, the second lens unit L2 moves toward the image side.

The zoom lens L0 according to a sixth exemplary embodiment has a configuration similar to that of the zoom lens L0 according to the fifth exemplary embodiment.

The zoom lens L0 according to a seventh exemplary embodiment consists of the first lens unit L1 having negative refractive power, the second lens unit L2 having positive refractive power, the intermediate unit LM, and the final lens unit LN having positive refractive power, which are arranged in this order from the object side to the image side. The intermediate unit LM consists of the third lens unit L3 having positive refractive power, the first intermediate lens unit Lm1 having negative refractive power, the second intermediate lens unit Lm2 having positive refractive power, and the third intermediate lens unit Lm3 having negative refractive power, which are arranged in this order from the object side to the image side.

The first lens unit L1, the first intermediate lens unit Lm1, and the final lens unit LN do not move with respect to the image plane IP during zooming. During zooming from the wide angle end to the telephoto end, the second lens unit L2 and the second intermediate lens unit Lm2 move monotonously toward the object side.

During zooming from the wide angle end to the intermediate zoom position, the third lens unit L3 moves monotonously toward the object side while widening the interval between the third lens unit L3 and the second lens unit L2. During zooming from the intermediate zoom position to the telephoto end, the third lens unit L3 moves monotonously toward the object side while narrowing down the interval between the third lens unit L3 and the second lens unit L2.

During zooming from the wide angle end to the intermediate zoom position, the third intermediate lens unit Lm3 moves monotonously toward the object side while narrowing down the interval between the third intermediate lens unit Lm3 and the second intermediate lens unit Lm2. During zooming from the intermediate zoom position to the telephoto end, the third intermediate lens unit Lm3 moves monotonously toward the object side while widening the interval between the third intermediate lens unit Lm3 and the second intermediate lens unit Lm2.

During focusing from the infinite distance to the close distance, the third intermediate lens unit Lm3 moves toward the image side.

The zoom lens L0 according to an eighth exemplary embodiment has a configuration similar to that of the zoom lens L0 according to the first exemplary embodiment.

The zoom lens L0 according to a ninth exemplary embodiment has a configuration similar to that of the zoom lens L0 according to the first exemplary embodiment.

The zoom lens L0 according to a tenth exemplary embodiment has a configuration similar to that of the zoom lens L0 according to the first exemplary embodiment.

The zoom lens L0 according to an eleventh exemplary embodiment includes a configuration similar to that of the zoom lens L0 according to the first exemplary embodiment.

The zoom lens L0 according to a twelfth exemplary embodiment includes a configuration similar to that of the zoom lens L0 according to the first exemplary embodiment.

The zoom lens L0 according to a thirteenth exemplary embodiment has a configuration similar to that of the zoom lens L0 according to the first exemplary embodiment.

First to thirteenth numerical examples corresponding to the first to thirteenth exemplary embodiments will be described below.

In surface data of each of the numerical examples, r is a curvature radius of each optical surface, and d (mm) is an interval on the axis (a distance on the optical axis) between an m-th surface and an (m+1)-th surface. Here, m is a surface number counted from a light incident side. Further, nd is a refractive index of each optical member with respect to a d-line, and vd is the Abbe number of the optical member. The Abbe number vd of a material is a value defined by the following expression, where Nd, NF, NC, and Ng are refractive indices at a d-line (587.6 nm), an F-line (486.1 nm), a C-line (656.3 nm), and a g-line (wavelength 435.8 nm) of Fraunhofer lines.

vd=(Nd−1)/(NF−NC)

In each of the numerical examples, the focal length (mm), F number, and half angle of view (°) are all values in a case where the zoom lens of each of the exemplary embodiments is focused on an object at infinity. A back focus BF is a distance from a final lens surface to an image plane. A total optical length is a value obtained by adding the back focus to a distance from a first lens surface to the final lens surface. The lens unit is not limited to a unit consisting of a plurality of lenses but may be a unit consisting of one lens.

In a case where an optical surface is aspherical, a symbol * is added to the right side of the surface number. An aspherical shape can be expressed by following expression, where X is a displacement amount from the surface vertex in the optical axis direction, h is a height from the optical axis in a direction perpendicular to the optical axis, R is a paraxial curvature radius, K is a conic constant, and A4, A6, A8, and A10 are aspherical coefficients of each order. In each aspherical coefficient, “e±**” means “*10^{±}**”.

$$x = ( {h}^{2} / R ) / [ 1 + {\{ 1 - ( 1 + K ) {( h / R )}^{2} \}}^{1 / 2} ] + A 4 * {h}^{4} + A 6 * {h}^{6} + A 8 * {h}^{8} + A 10 * {h}^{10}$$

### First Numerical Example

Unit mm
Surface Data

| Surface number | r | d | nd | νd |
|---|---|---|---|---|
| 1 | 55.971 | 1.50 | 1.80400 | 46.5 |
| 2 | 19.923 | 6.30 | | |
| 3 | 129.400 | 1.50 | 1.72916 | 54.7 |
| 4 | 45.014 | 2.92 | | |
| 5 | −266.970 | 1.20 | 1.49700 | 81.7 |
| 6 | 61.325 | 0.15 | | |
| 7 | 30.898 | 2.59 | 1.85478 | 24.8 |
| 8 | 53.178 | (variable) | | |
| 9 | 78.476 | 1.00 | 1.85478 | 24.8 |
| 10 | 31.335 | 3.98 | 1.59282 | 68.6 |
| 11 | −67.036 | 0.15 | | |
| 12* | 40.595 | 4.06 | 1.58313 | 59.4 |
| 13* | −122.866 | (variable) | | |
| 14 (aperture) | ∞ | 1.67 | | |
| 15 | −181.924 | 1.00 | 1.77250 | 49.6 |
| 16 | 23.537 | 1.81 | 2.00069 | 25.5 |
| 17 | 50.288 | 3.43 | | |
| 18 | −22.199 | 1.00 | 1.72916 | 54.7 |
| 19 | −27.406 | (variable) | | |
| 20* | 27.941 | 7.79 | 1.49700 | 81.7 |
| 21* | −25.717 | 0.15 | | |
| 22 | 46.962 | 5.59 | 1.49700 | 81.7 |
| 23 | −28.833 | 1.00 | 1.85478 | 24.8 |
| 24 | −77.823 | (variable) | | |
| 25 | 36.024 | 1.00 | 1.69680 | 55.5 |
| 26 | 16.940 | 7.83 | | |
| 27 | −18.145 | 1.50 | 1.58313 | 59.4 |
| 28* | −47.332 | (variable) | | |
| 29 | −56.752 | 5.82 | 1.48749 | 70.2 |
| 30 | −25.524 | 13.50 | | |
| Image plane | ∞ | | | |

Aspherical Surface Data
12th surface

| | | | | |
|---|---|---|---|---|
| K = 0.00000e+00 | A4 = −9.02395e−06 | A6 = −1.00648e−08 | A8 = −2.55852e−11 | A10 = −7.53599e−15 |

13th surface

| | | |
|---|---|---|
| K = 0.00000e+00 | A4 = −9.91511e−06 | A6 = −3.22097e−09 |

20th surface

| | | | |
|---|---|---|---|
| K = 0.00000e+00 | A4 = −1.79834e−05 | A6 = −5.28858e−09 | A8 = −1.27278e−11 |

21st surface

| | | |
|---|---|---|
| K = 0.00000e+00 | A4 = 1.06157e−05 | A6 = −1.36403e−08 |

28th surface

| | | | | |
|---|---|---|---|---|
| K = 0.00000e+00 | A4 = −2.90392e−06 | A6 = 9.12665e−09 | A8 = 1.49351e−10 | A10 = −8.38576e−13 |

Various Data
Zoom ratio 2.35

| | Wide angle | Intermediate | Telephoto |
|---|---|---|---|
| Focal length | 20.60 | 32.25 | 48.50 |
| F number | 4.08 | 4.08 | 4.12 |
| Half angle of view | 42.00 | 33.44 | 24.04 |
| Image height | 18.55 | 21.29 | 21.63 |
| Total optical length | 125.00 | 125.00 | 125.00 |
| BF | 13.50 | 13.50 | 13.50 |
| d8 | 26.22 | 15.50 | 4.78 |
| d13 | 1.50 | 12.22 | 22.95 |
| d19 | 14.08 | 8.42 | 1.50 |
| d24 | 1.82 | 1.50 | 4.55 |
| d28 | 2.93 | 8.91 | 12.78 |

Zoom Lens Unit Data

| Unit | Start surface | Focal length |
|---|---|---|
| 1 | 1 | −27.81 |
| 2 | 9 | 33.50 |
| 3 | 14 | −49.61 |
| 4 | 20 | 22.93 |
| 5 | 25 | −22.97 |
| 6 | 29 | 89.67 |

### Second Numerical Example

Unit mm
Surface Data

| Surface number | r | d | nd | νd |
|---|---|---|---|---|
| 1 | 45.250 | 1.50 | 1.72916 | 54.7 |
| 2 | 20.814 | 6.60 | | |
| 3 | 84.708 | 1.50 | 1.72916 | 54.7 |
| 4 | 31.938 | 4.36 | | |
| 5 | −259.228 | 1.20 | 1.49700 | 81.7 |
| 6 | 55.425 | 0.15 | | |
| 7 | 30.626 | 2.57 | 1.85478 | 24.8 |
| 8 | 49.293 | (variable) | | |
| 9* | 49.097 | 3.43 | 1.58313 | 59.4 |
| 10 | 148.017 | 1.52 | | |
| 11 | −59.949 | 1.00 | 1.77047 | 29.7 |
| 12 | 27.768 | 4.48 | 1.74400 | 44.8 |
| 13 | −90.940 | 0.15 | | |
| 14* | 28.349 | 5.39 | 1.58313 | 59.4 |
| 15 | −64.670 | (variable) | | |
| 16 (aperture) | ∞ | 1.63 | | |
| 17 | −201.577 | 1.00 | 1.77250 | 49.6 |
| 18 | 22.220 | 1.71 | 2.00069 | 25.5 |
| 19 | 45.454 | 3.32 | | |
| 20 | −19.997 | 1.00 | 1.77250 | 49.6 |
| 21 | −23.310 | (variable) | | |
| 22* | 32.017 | 6.90 | 1.49700 | 81.7 |
| 23* | −29.004 | 0.15 | | |
| 24 | 63.721 | 5.49 | 1.49700 | 81.7 |
| 25 | −24.855 | 1.00 | 1.85478 | 24.8 |
| 26 | −56.137 | (variable) | | |
| 27 | 53.637 | 1.00 | 1.65160 | 58.5 |
| 28 | 22.229 | 9.11 | | |
| 29 | −18.121 | 1.00 | 1.72916 | 54.7 |
| 30 | −32.593 | (variable) | | |
| 31 | −57.886 | 3.29 | 1.90043 | 37.4 |
| 32 | −34.604 | 13.50 | | |
| Image plane | ∞ | | | |

Aspherical Surface Data
9th surface

| | | | | |
|---|---|---|---|---|
| K = 0.00000e+00 | A4 = 1.51622e−05 | A6 = −2.31638e−08 | A8 = 1.08693e−10 | A10 = −2.67591e−13 |

14th surface

| | | | | |
|---|---|---|---|---|
| K = 0.00000e+00 | A4 = −2.07940e−05 | A6 = 1.32622e−08 | A8 = −1.35712e−10 | A10 = 4.25991e−13 |

22nd surface

| | | | |
|---|---|---|---|
| K = 0.00000e+00 | A4 = −1.46478e−05 | A6 = 1.17508e−08 | A8 = −1.06702e−11 |

23rd surface

| | | |
|---|---|---|
| K = 0.00000e+00 | A4 = 3.07952e−06 | A6 = 2.13796e−09 |

Various Data
Zoom ratio 2.3

| | Wide angle | Intermediate | Telephoto |
|---|---|---|---|
| Focal length | 20.60 | 32.36 | 48.50 |
| F number | 4.08 | 4.08 | 4.12 |
| Half angle of view | 42.13 | 33.40 | 24.04 |
| Image height | 18.64 | 21.34 | 21.64 |
| Total optical length | 127.50 | 127.50 | 127.50 |
| BF | 13.50 | 13.50 | 13.50 |
| d 8 | 23.35 | 12.59 | 1.83 |
| d15 | 1.50 | 12.26 | 23.02 |
| d21 | 12.86 | 7.86 | 1.50 |
| d26 | 2.74 | 1.50 | 4.33 |
| d30 | 3.07 | 9.31 | 12.84 |

Zoom Lens Unit Data

| Unit | Start surface | Focal length |
|---|---|---|
| 1 | 1 | −28.63 |
| 2 | 9 | 32.28 |
| 3 | 16 | −49.53 |
| 4 | 22 | 25.60 |
| 5 | 27 | −27.30 |
| 6 | 31 | 89.56 |

### Third Numerical Example

Unit mm
Surface Data

| Surface number | r | d | nd | νd |
|---|---|---|---|---|
| 1 | 44.745 | 1.50 | 1.72916 | 54.7 |
| 2 | 21.886 | 6.85 | | |
| 3 | 78.467 | 1.50 | 1.72916 | 54.7 |
| 4 | 32.433 | 4.48 | | |
| 5 | −878.796 | 1.20 | 1.49700 | 81.7 |
| 6 | 48.351 | 0.15 | | |
| 7 | 29.472 | 2.58 | 1.84666 | 23.8 |
| 8 | 43.453 | (variable) | | |
| 9 | 71.856 | 3.46 | 1.90043 | 37.4 |
| 10 | −65.139 | 0.75 | | |
| 11 | −42.357 | 1.00 | 1.85478 | 24.8 |
| 12 | 77.478 | 2.93 | 1.69680 | 55.5 |
| 13 | −84.412 | 0.15 | | |
| 14* | 56.676 | 4.77 | 1.58313 | 59.4 |
| 15* | −59.686 | (variable) | | |
| 16 (aperture) | ∞ | 1.62 | | |
| 17 | −197.549 | 1.00 | 1.77250 | 49.6 |
| 18 | 21.757 | 1.63 | 2.00069 | 25.5 |
| 19 | 43.574 | 3.08 | | |
| 20 | −21.212 | 1.00 | 1.83481 | 42.7 |
| 21 | −25.869 | (variable) | | |
| 22* | 36.089 | 6.24 | 1.49700 | 81.7 |
| 23* | −30.061 | 0.15 | | |
| 24 | 53.799 | 5.45 | 1.49700 | 81.7 |
| 25 | −25.813 | 1.00 | 1.85478 | 24.8 |
| 26 | −47.330 | (variable) | | |
| 27 | 46.807 | 1.00 | 1.62041 | 60.3 |
| 28 | 21.004 | 8.66 | | |
| 29 | −17.995 | 1.00 | 1.65160 | 58.5 |
| 30 | −36.676 | (variable) | | |
| 31 | −57.878 | 4.12 | 1.65160 | 58.5 |
| 32 | −30.358 | 13.50 | | |
| Image plane | ∞ | | | |

Aspherical Surface Data
14th surface

| | | | | |
|---|---|---|---|---|
| K = 0.00000e+00 | A4 = −6.66695e−06 | A6 = 2.23155e−09 | A8 = −4.18577e−11 | A10 = 1.67131e−13 |

15th surface

| | | |
|---|---|---|
| K = 0.00000e+00 | A4 = −5.35653e−06 | A6 = 7.22957e−09 |

22nd surface

| | | | |
|---|---|---|---|
| K = 0.00000e+00 | A4 = −1.59313e−05 | A6 = 4.71359e−09 | A8 = 7.57612e−12 |

23rd surface

| | | |
|---|---|---|
| K = 0.00000e+00 | A4 = 1.51739e−06 | A6 = −7.78004e−09 |

Various Data
Zoom ratio 2.35

| | Wide angle | Intermediate | Telephoto |
|---|---|---|---|
| Focal length | 20.60 | 32.51 | 48.50 |
| F number | 4.08 | 4.08 | 4.12 |
| Half angle of view | 42.13 | 33.29 | 24.04 |
| Image height | 18.64 | 21.34 | 21.64 |
| Total optical length | 127.50 | 127.50 | 127.50 |
| BF | 13.50 | 13.50 | 13.50 |
| d 8 | 27.87 | 16.96 | 6.05 |
| d15 | 1.50 | 12.41 | 23.32 |
| d21 | 11.34 | 6.89 | 1.50 |
| d26 | 2.97 | 1.50 | 3.87 |
| d30 | 3.04 | 8.97 | 11.99 |

Zoom Lens Unit Data

| Unit | Start surface | Focal length |
|---|---|---|
| 1 | 1 | −29.98 |
| 2 | 9 | 32.41 |
| 3 | 16 | −44.06 |
| 4 | 22 | 24.32 |
| 5 | 27 | −27.56 |
| 6 | 31 | 92.53 |

### Fourth Numerical Example

Unit mm
Surface Data

| Surface number | r | d | nd | νd |
|---|---|---|---|---|
| 1 | 30.582 | 1.50 | 1.72916 | 54.7 |
| 2 | 16.036 | 4.93 | | |
| 3 | 73.716 | 1.50 | 1.77250 | 49.6 |
| 4 | 29.329 | 4.69 | | |
| 5 | −59.476 | 1.20 | 1.49700 | 81.7 |
| 6 | 96.505 | 0.15 | | |
| 7 | 28.528 | 2.31 | 1.73800 | 32.3 |
| 8 | 64.875 | (variable) | | |
| 9 | 47.059 | 4.18 | 1.56873 | 63.1 |
| 10 | −25.918 | 0.97 | | |
| 11 | −18.923 | 1.00 | 1.77047 | 29.7 |
| 12 | −67.295 | 0.15 | | |
| 13* | 436.420 | 5.45 | 1.58313 | 59.4 |
| 14 | −19.467 | (variable) | | |
| 15 (aperture) | ∞ | 1.73 | | |
| 16 | −119.997 | 1.00 | 1.69680 | 55.5 |
| 17 | 23.566 | 1.59 | 2.00069 | 25.5 |
| 18 | 44.365 | 3.19 | | |
| 19 | −26.212 | 1.00 | 1.61772 | 49.8 |
| 20 | −38.635 | (variable) | | |
| 21* | 29.301 | 8.00 | 1.49700 | 81.7 |
| 22* | −22.742 | 0.15 | | |
| 23 | 831.741 | 4.61 | 1.49700 | 81.7 |
| 24 | −24.142 | 1.00 | 1.85478 | 24.8 |
| 25 | −43.713 | 1.37 | | |
| 26 | 594.224 | 1.00 | 1.56873 | 63.1 |
| 27 | 23.152 | (variable) | | |
| 28 | −52.988 | 1.50 | 1.85150 | 40.8 |
| 29 | 292.088 | 0.15 | | |
| 30* | 49.699 | 4.94 | 1.76450 | 49.1 |
| 31 | 503.807 | 14.35 | | |
| Image plane | ∞ | | | |

Aspherical Surface Data
13th surface

| | | | | |
|---|---|---|---|---|
| K = 0.00000e+00 | A4 = −2.01449e−05 | A6 = −2.02568e−08 | A8 = 1.05446e−10 | A10 = −4.88033e−13 |

21st surface

| | | | |
|---|---|---|---|
| K = 0.00000e+00 | A4 = −1.85451e−05 | A6 = 2.83729e−08 | A8 = −8.75848e−11 |

22nd surface

| | | |
|---|---|---|
| K = 0.00000e+00 | A4 = 2.01030e−05 | A6 = −1.68040e−09 |

30th surface

| | | | |
|---|---|---|---|
| K = 0.00000e+00 | A4 = 2.29034e−06 | A6 = −6.38070e−09 | A8 = 7.67247e−12 |

Various Data
Zoom ratio 1.96

| | Wide angle | Intermediate | Telephoto |
|---|---|---|---|
| Focal length | 24.72 | 32.72 | 48.50 |
| F number | 4.08 | 4.08 | 4.12 |
| Half angle of view | 37.68 | 33.00 | 24.04 |
| Image height | 19.09 | 21.25 | 21.64 |
| Total optical length | 118.16 | 118.16 | 118.16 |
| BF | 14.35 | 14.35 | 14.35 |
| d 8 | 18.36 | 10.47 | 2.58 |
| d14 | 1.50 | 9.39 | 17.28 |
| d20 | 9.74 | 9.16 | 1.50 |
| d27 | 14.96 | 15.53 | 23.19 |

Zoom Lens Unit Data

| Unit | Start surface | Focal length |
|---|---|---|
| 1 | 1 | −27.30 |
| 2 | 9 | 28.94 |
| 3 | 15 | −43.65 |
| 4 | 21 | 40.79 |
| 5 | 28 | −201.94 |

### Fifth Numerical Example

Unit mm
Surface Data

| Surface number | r | d | nd | νd |
|---|---|---|---|---|
| 1 | 56.573 | 1.50 | 1.72916 | 54.7 |
| 2 | 25.928 | 4.82 | | |
| 3 | 127.534 | 1.50 | 1.72916 | 54.7 |
| 4 | 36.670 | 4.31 | | |
| 5 | −114.076 | 1.20 | 1.49700 | 81.7 |
| 6 | 47.066 | 0.15 | | |
| 7 | 32.296 | 2.52 | 1.85478 | 24.8 |
| 8 | 53.393 | (variable) | | |
| 9* | 48.857 | 4.42 | 1.49700 | 81.7 |
| 10 | −51.434 | (variable) | | |
| 11 | −24.067 | 1.00 | 1.77047 | 29.7 |
| 12 | 60.475 | 4.44 | 1.85150 | 40.8 |
| 13 | −36.920 | 0.15 | | |
| 14* | 50.491 | 6.02 | 1.58313 | 59.4 |
| 15 | −43.687 | (variable) | | |
| 16 (aperture) | ∞ | 1.63 | | |
| 17 | 974.139 | 1.00 | 1.85150 | 40.8 |
| 18 | 19.376 | 1.88 | 2.00069 | 25.5 |
| 19 | 40.712 | (variable) | | |
| 20 | 41.312 | 6.11 | 1.49700 | 81.7 |
| 21 | −15.487 | 1.00 | 1.80610 | 33.3 |
| 22 | −29.411 | 2.95 | | |
| 23 | −24.240 | 2.28 | 1.58313 | 59.4 |
| 24* | −17.010 | 6.67 | | |
| 25 | −16.347 | 1.00 | 1.72916 | 54.7 |
| 26 | −85.571 | (variable) | | |
| 27 | −1000.000 | 3.74 | 1.71700 | 47.9 |
| 28 | −55.052 | 20.30 | | |
| Image plane | ∞ | | | |

Aspherical Surface Data
9th surface

| | | | | |
|---|---|---|---|---|
| K = 0.00000e+00 | A4 = −4.57176e−06 | A6 = 2.13530e−09 | A8 = −3.07486e−11 | A10 = 8.34198e−14 |

14th surface

| | | | | |
|---|---|---|---|---|
| K = 0.00000e+00 | A4 = −5.48417e−06 | A6 = −4.69605e−09 | A8 = 5.67788e−12 | A10 = −3.51109e−14 |

24th surface

| | | | |
|---|---|---|---|
| K = 0.00000e+00 | A4 = 5.80310e−06 | A6 = 2.45746e−08 | A8 = −4.73642e−11 |

Various Data
Zoom ratio 2.35

| | Wide angle | Intermediate | Telephoto |
|---|---|---|---|
| Focal length | 24.72 | 41.29 | 58.20 |
| F number | 4.08 | 4.08 | 4.12 |
| Half angle of view | 38.10 | 27.52 | 20.39 |
| Image height | 19.39 | 21.51 | 21.63 |
| Total optical length | 127.50 | 127.50 | 127.50 |
| BF | 20.30 | 20.30 | 20.30 |
| d 8 | 23.73 | 7.70 | 1.00 |
| d10 | 6.61 | 11.36 | 6.77 |
| d15 | 1.00 | 12.29 | 23.58 |
| d19 | 14.57 | 6.10 | 1.23 |
| d26 | 1.00 | 9.47 | 14.34 |

Zoom Lens Unit Data

| Unit | Start surface | Focal length |
|---|---|---|
| 1 | 1 | −28.00 |
| 2 | 9 | 51.16 |
| 3 | 11 | 46.81 |
| 4 | 16 | −63.29 |
| 5 | 20 | 348.73 |
| 6 | 27 | 81.12 |

### Sixth Numerical Example

Unit mm
Surface Data

| Surface number | r | d | nd | νd |
|---|---|---|---|---|
| 1 | 56.796 | 1.50 | 1.72916 | 54.7 |
| 2 | 27.536 | 4.77 | | |
| 3 | 142.693 | 1.50 | 1.72916 | 54.7 |
| 4 | 38.371 | 4.39 | | |
| 5 | −110.747 | 1.20 | 1.49700 | 81.7 |
| 6 | 41.815 | 0.15 | | |
| 7 | 33.190 | 2.84 | 1.85478 | 24.8 |
| 8 | 62.845 | (variable) | | |
| 9* | 74.051 | 3.87 | 1.49700 | 81.7 |
| 10 | −49.579 | (variable) | | |
| 11 | −29.430 | 1.00 | 1.77047 | 29.7 |
| 12 | 43.467 | 4.33 | 1.85150 | 40.8 |
| 13 | −47.752 | 0.15 | | |
| 14* | 38.227 | 5.42 | 1.58313 | 59.4 |
| 15 | −58.313 | (variable) | | |
| 16 (aperture) | ∞ | 1.28 | | |
| 17 | −106.596 | 1.00 | 1.85150 | 40.8 |
| 18 | 27.329 | 1.84 | 2.00069 | 25.5 |
| 19 | 87.076 | (variable) | | |
| 20* | 31.500 | 6.32 | 1.49700 | 81.7 |
| 21 | −16.054 | 1.00 | 1.80610 | 33.3 |
| 22 | −26.499 | 11.68 | | |
| 23 | −12.974 | 1.00 | 1.90043 | 37.4 |
| 24 | −29.352 | (variable) | | |
| 25 | −1000.000 | 3.95 | 1.80518 | 25.4 |
| 26 | −54.396 | 17.55 | | |
| Image plane | ∞ | | | |

Aspherical Surface Data
9th surface

| | | | | |
|---|---|---|---|---|
| K = 0.00000e+00 | A4 = −2.07568e−06 | A6 = 3.71698e−09 | A8 = −6.22940e−11 | A10 = 1.96262e−13 |

14th surface

| | | | | |
|---|---|---|---|---|
| K = 0.00000e+00 | A4 = −6.51029e−06 | A6 = −3.63905e−09 | A8 = −1.42223e−11 | A10 = 4.62400e−14 |

20th surface

| | | | |
|---|---|---|---|
| K = 0.00000e+00 | A4 = 1.55170e−05 | A6 = 4.32459e−08 | A8 = 3.53245e−10 |

Various Data
Zoom ratio 2.35

| | Wide angle | Intermediate | Telephoto |
|---|---|---|---|
| Focal length | 24.72 | 40.65 | 58.20 |
| F number | 4.08 | 4.08 | 4.12 |
| Half angle of view | 38.11 | 27.90 | 20.39 |
| Image height | 19.39 | 21.52 | 21.63 |
| Total optical length | 123.00 | 123.00 | 123.00 |
| BF | 17.55 | 17.55 | 17.55 |
| d 8 | 23.79 | 8.06 | 1.34 |
| d10 | 6.24 | 11.00 | 6.75 |
| d15 | 1.00 | 11.97 | 22.94 |
| d19 | 14.25 | 6.85 | 1.00 |
| d24 | 1.00 | 8.40 | 14.25 |

Zoom Lens Unit Data

| Unit | Start surface | Focal length |
|---|---|---|
| 1 | 1 | −29.99 |
| 2 | 9 | 60.38 |
| 3 | 11 | 46.47 |
| 4 | 16 | −71.05 |
| 5 | 20 | 455.17 |
| 6 | 25 | 71.31 |

### Seventh Numerical Example

Unit mm
Surface Data

| Surface number | r | d | nd | νd |
|---|---|---|---|---|
| 1 | 54.338 | 1.50 | 1.72916 | 54.7 |
| 2 | 24.780 | 5.96 | | |
| 3 | 89.186 | 1.50 | 1.72916 | 54.7 |
| 4 | 34.953 | 4.40 | | |
| 5 | −686.291 | 1.20 | 1.49700 | 81.7 |
| 6 | 34.043 | 0.15 | | |
| 7 | 30.277 | 2.98 | 1.85478 | 24.8 |
| 8 | 50.476 | (variable) | | |
| 9* | 67.232 | 2.12 | 1.58313 | 59.4 |
| 10 | 430.017 | 1.00 | | |
| 11 | −98.896 | 1.00 | 1.77047 | 29.7 |
| 12 | 25.513 | 5.27 | 1.83481 | 42.7 |
| 13 | −125.479 | (variable) | | |
| 14* | 29.483 | 5.16 | 1.49700 | 81.7 |
| 15 | −61.397 | (variable) | | |
| 16 (aperture) | ∞ | 1.03 | | |
| 17 | −1211.455 | 1.00 | 1.80400 | 46.5 |
| 18 | 21.512 | 1.84 | 2.00069 | 25.5 |
| 19 | 43.075 | 2.72 | | |
| 20 | −26.597 | 1.00 | 1.77250 | 49.6 |
| 21 | −34.929 | (variable) | | |
| 22* | 32.089 | 5.34 | 1.49700 | 81.7 |
| 23* | −32.017 | 0.15 | | |
| 24 | 36.754 | 5.61 | 1.49700 | 81.7 |
| 25 | −26.999 | 1.00 | 1.85478 | 24.8 |
| 26 | −53.076 | (variable) | | |
| 27 | 64.051 | 1.00 | 1.72916 | 54.7 |
| 28 | 19.236 | 10.20 | | |
| 29 | −19.040 | 1.00 | 1.72916 | 54.7 |
| 30 | −39.959 | (variable) | | |
| 31 | −57.820 | 5.16 | 1.74400 | 44.8 |
| 32 | −28.445 | 13.50 | | |
| Image plane | ∞ | | | |

Aspherical Surface Data
9th surface

| | | | | |
|---|---|---|---|---|
| K = 0.00000e+00 | A4 = 1.57975e−06 | A6 = −1.49605e−08 | A8 = 9.56357e−11 | A10 = −3.40589e−13 |

14th surface

| | | | | |
|---|---|---|---|---|
| K = 0.00000e+00 | A4 = −1.00522e−05 | A6 = 2.08652e−09 | A8 = −5.95610e−11 | A10 = 1.71359e−13 |

22nd surface

| | | | |
|---|---|---|---|
| K = 0.00000e+00 | A4 = −1.31680e−05 | A6 = 1.67994e−08 | A8 = −3.81526e−12 |

23rd surface

| | | |
|---|---|---|
| K = 0.00000e+00 | A4 = 8.24165e−06 | A6 = 1.26404e−08 |

Various Data
Zoom ratio 2.83

| | Wide angle | Intermediate | Telephoto |
|---|---|---|---|
| Focal length | 20.60 | 30.17 | 58.20 |
| F number | 4.08 | 4.08 | 4.12 |
| Half angle of view | 42.15 | 34.80 | 20.39 |
| Image height | 18.65 | 20.97 | 21.63 |
| Total optical length | 130.00 | 130.00 | 130.00 |
| BF | 13.50 | 13.50 | 13.50 |
| d 8 | 28.21 | 14.94 | 1.74 |
| d13 | 1.00 | 5.99 | 1.00 |
| d15 | 1.00 | 9.28 | 27.46 |
| d21 | 13.69 | 9.86 | 1.00 |
| d26 | 1.32 | 1.00 | 3.04 |
| d30 | 2.00 | 6.15 | 12.96 |

Zoom Lens Unit Data

| Unit | Start surface | Focal length |
|---|---|---|
| 1 | 1 | −28.76 |
| 2 | 9 | 115.59 |
| 3 | 14 | 40.85 |
| 4 | 16 | −47.23 |
| 5 | 22 | 22.32 |
| 6 | 27 | −19.69 |
| 7 | 31 | 70.01 |

### Eighth Numerical Example

Unit mm
Surface Data

| Surface number | r | d | nd | νd |
|---|---|---|---|---|
| 1 | 41.440 | 1.50 | 1.90043 | 37.4 |
| 2 | 19.957 | 6.17 | | |
| 3 | 132.238 | 1.50 | 1.80400 | 46.5 |
| 4 | 32.151 | 4.69 | | |
| 5 | −66.010 | 1.20 | 1.49700 | 81.7 |
| 6 | 71.703 | 0.15 | | |
| 7 | 37.710 | 2.70 | 1.85478 | 24.8 |
| 8 | 97.739 | (variable) | | |
| 9* | 96.988 | 3.28 | 1.58313 | 59.4 |
| 10* | −92.129 | 0.15 | | |
| 11 | 55.846 | 3.79 | 1.59282 | 68.6 |
| 12 | −32.452 | 1.00 | 1.85478 | 24.8 |
| 13 | −50.684 | (variable) | | |
| 14 | −60.007 | 1.00 | 1.58913 | 61.1 |
| 15 | 24.460 | 1.86 | 1.90366 | 31.3 |
| 16 | 47.766 | 2.26 | | |
| 17 (aperture) | ∞ | (variable) | | |
| 18 | 22.524 | 7.67 | 1.49700 | 81.7 |
| 19 | −22.543 | 1.00 | 1.90366 | 31.3 |
| 20 | −54.292 | 0.15 | | |
| 21* | 42.203 | 5.41 | 1.49700 | 81.7 |
| 22* | −27.553 | (variable) | | |
| 23 | 32.781 | 1.01 | 1.72916 | 54.7 |
| 24 | 14.302 | 9.78 | | |
| 25 | −28.558 | 1.50 | 1.58313 | 59.4 |
| 26* | −114.619 | (variable) | | |
| 27 | −56.891 | 6.06 | 1.49700 | 81.7 |
| 28 | −25.785 | 13.50 | | |
| Image plane | ∞ | | | |

Aspherical Surface Data
9th surface

| | | | |
|---|---|---|---|
| K = 0.00000e+00 | A4 = −1.18326e−05 | A6 = −9.52044e−09 | A8 = −3.43097e−11 |

10th surface

| | | |
|---|---|---|
| K = 0.00000e+00 | A4 = −8.46975e−06 | A6 = −1.36754e−08 |

21st surface

| | | | |
|---|---|---|---|
| K = 0.00000e+00 | A4 = −4.73747e−05 | A6 = −1.09658e−07 | A8 = 4.70777e−11 |

22nd surface

| | | | |
|---|---|---|---|
| K = 0.00000e+00 | A4 = −4.61456e−06 | A6 = −6.55507e−08 | A8 = 2.37099e−11 |

26th surface

| | | | | |
|---|---|---|---|---|
| K = 0.00000e+00 | A4 = 7.89272e−06 | A6 = −5.60861e−08 | A8 = 1.87916e−10 | A10 = −1.66382e−12 |

Various Data
Zoom ratio 2.35

| | Wide angle | Intermediate | Telephoto |
|---|---|---|---|
| Focal length | 18.54 | 29.45 | 43.65 |
| F number | 4.08 | 4.08 | 4.12 |
| Half angle of view | 45.15 | 35.89 | 26.37 |
| Image height | 18.63 | 21.31 | 21.63 |
| Total optical length | 125.00 | 125.00 | 125.00 |
| BF | 13.50 | 13.50 | 13.50 |
| d 8 | 23.35 | 13.93 | 4.50 |
| d13 | 1.50 | 10.93 | 20.35 |
| d17 | 18.86 | 9.78 | 1.50 |
| d22 | 1.69 | 1.50 | 4.42 |
| d26 | 2.26 | 11.54 | 16.89 |

Zoom Lens Unit Data

| Unit | Start surface | Focal length |
|---|---|---|
| 1 | 1 | −22.28 |
| 2 | 9 | 32.49 |
| 3 | 14 | −63.06 |
| 4 | 18 | 22.22 |
| 5 | 23 | −21.20 |
| 6 | 27 | 89.13 |

### Ninth Numerical Example

Unit mm
Surface Data

| Surface number | r | d | nd | νd |
|---|---|---|---|---|
| 1 | 50.596 | 1.50 | 1.85150 | 40.8 |
| 2 | 18.423 | 6.56 | | |
| 3 | 149.525 | 1.50 | 1.72916 | 54.7 |
| 4 | 40.636 | 3.21 | | |
| 5 | −140.683 | 1.20 | 1.49700 | 81.7 |
| 6 | 54.204 | 0.15 | | |
| 7 | 31.078 | 2.90 | 1.85478 | 24.8 |
| 8 | 68.206 | (variable) | | |
| 9 | 123.911 | 1.00 | 1.85025 | 30.1 |
| 10 | 22.987 | 4.68 | 1.65160 | 58.5 |
| 11 | −53.948 | 0.15 | | |
| 12* | 38.255 | 4.26 | 1.58313 | 59.4 |
| 13* | −93.489 | (variable) | | |
| 14 (aperture) | ∞ | 1.64 | | |
| 15 | −219.206 | 1.00 | 1.80400 | 46.5 |
| 16 | 23.026 | 1.90 | 2.00069 | 25.5 |
| 17 | 54.665 | 3.45 | | |
| 18 | −20.545 | 1.00 | 1.80400 | 46.5 |
| 19 | −24.118 | (variable) | | |
| 20* | 32.852 | 7.69 | 1.49700 | 81.7 |
| 21* | −26.103 | 0.15 | | |
| 22 | 31.150 | 6.18 | 1.49700 | 81.7 |
| 23 | −38.254 | 1.00 | 1.85478 | 24.8 |
| 24 | −129.696 | (variable) | | |
| 25 | 60.987 | 1.00 | 1.85150 | 40.8 |
| 26 | 19.226 | 6.17 | | |
| 27 | −19.696 | 1.50 | 1.58313 | 59.4 |
| 28* | −36.920 | (variable) | | |
| 29 | −56.986 | 6.21 | 1.49700 | 81.7 |
| 30 | −25.346 | 13.50 | | |
| Image plane | ∞ | | | |

Aspherical Surface Data
12th surface

| | | | | |
|---|---|---|---|---|
| K = 0.00000e+00 | A4 = −7.09347e−06 | A6 = −1.49108e−08 | A8 = −4.04547e−11 | A10 = 1.53642e−14 |

13th surface

| | | |
|---|---|---|
| K = 0.00000e+00 | A4 = −1.01623e−05 | A6 = −1.40782e−08 |

20th surface

| | | | |
|---|---|---|---|
| K = 0.00000e+00 | A4 = −1.31686e−05 | A6 = −2.60822e−09 | A8 = 1.53174e−12 |

21st surface

| | | |
|---|---|---|
| K = 0.00000e+00 | A4 = 1.01756e−05 | A6 = −3.50108e−09 |

28th surface

| | | | | |
|---|---|---|---|---|
| K = 0.00000e+00 | A4 = 9.50045e−06 | A6 = 2.36563e−08 | A8 = 1.25691e−10 | A10 = −5.30072e−13 |

Various Data
Zoom ratio 2.35

| | Wide angle | Intermediate | Telephoto |
|---|---|---|---|
| Focal length | 18.54 | 29.00 | 43.65 |
| F number | 4.08 | 4.08 | 4.12 |
| Half angle of view | 44.84 | 36.54 | 26.37 |
| Image height | 18.44 | 21.49 | 21.64 |
| Total optical length | 125.00 | 125.00 | 125.00 |
| BF | 13.50 | 13.50 | 13.50 |
| d 8 | 23.70 | 13.73 | 3.76 |
| d13 | 1.50 | 11.47 | 21.43 |
| d19 | 16.04 | 9.39 | 1.50 |
| d24 | 1.90 | 1.50 | 4.08 |
| d28 | 2.37 | 9.41 | 14.72 |

Zoom Lens Unit Data

| Unit | Start surface | Focal length |
|---|---|---|
| 1 | 1 | −24.08 |
| 2 | 9 | 31.86 |
| 3 | 14 | −54.31 |
| 4 | 20 | 22.13 |
| 5 | 25 | −22.08 |
| 6 | 29 | 86.23 |

### Tenth Numerical Example

Unit mm
Surface Data

| Surface number | r | d | nd | νd |
|---|---|---|---|---|
| 1 | 58.697 | 2.00 | 1.76450 | 49.1 |
| 2* | 21.767 | 3.32 | | |
| 3 | 38.714 | 1.50 | 1.83481 | 42.7 |
| 4 | 20.959 | 7.47 | | |
| 5 | −64.894 | 1.20 | 1.49700 | 81.5 |
| 6 | 25.687 | 5.00 | 1.77047 | 29.7 |
| 7 | 97.829 | (variable) | | |
| 8 | 33.056 | 1.00 | 1.85478 | 24.8 |
| 9 | 19.330 | 3.83 | 1.51823 | 58.9 |
| 10 | −139.181 | 0.15 | | |
| 11 | 33.951 | 2.59 | 1.52841 | 76.5 |
| 12 | −103.323 | (variable) | | |
| 13 (aperture) | ∞ | 1.90 | | |
| 14 | −48.037 | 2.42 | 2.00069 | 25.5 |
| 15 | −16.386 | 1.00 | 1.90043 | 37.4 |
| 16 | 807.343 | 2.89 | | |
| 17 | −19.763 | 1.00 | 1.48749 | 70.2 |
| 18 | −21.850 | (variable) | | |
| 19* | 29.813 | 7.00 | 1.49700 | 81.5 |
| 20* | −33.870 | 0.15 | | |
| 21 | 41.689 | 7.00 | 1.49700 | 81.5 |
| 22 | −24.832 | 0.90 | 1.85478 | 24.8 |
| 23 | −37.687 | (variable) | | |
| 24 | 42.207 | 1.00 | 1.90043 | 37.4 |
| 25 | 18.378 | 6.69 | | |
| 26* | −15.828 | 1.50 | 1.76450 | 49.1 |
| 27* | −24.724 | (variable) | | |
| 28 | −57.966 | 4.66 | 1.49700 | 81.5 |
| 29 | −28.192 | 14.00 | | |
| Image plane | ∞ | | | |

Aspherical Surface Data
2nd surface

| | | | | |
|---|---|---|---|---|
| K = 0.00000e+00 | A4 = −4.34926e−06 | A6 = −2.33849e−08 | A8 = 4.58313e−11 | A10 = −1.49569e−13 |

19th surface

| | | | |
|---|---|---|---|
| K = 0.00000e+00 | A4 = −1.22772e−05 | A6 = −3.46073e−09 | A8 = 2.87619e−11 |

20th surface

| | | | | |
|---|---|---|---|---|
| K = 0.00000e+00 | A4 = 1.92100e−05 | A6 = −3.82227e−08 | A8 = 4.64430e−11 | A10 = 3.78185e−14 |

26th surface

| | | | |
|---|---|---|---|
| K = 0.00000e+00 | A4 = 1.29444e−04 | A6 = −1.08636e−06 | A8 = 3.17187e−09 |

27th surface

| | | | | |
|---|---|---|---|---|
| K = 0.00000e+00 | A4 = 1.11929e−04 | A6 = −9.28670e−07 | A8 = 3.51613e−09 | A10 = −3.25660e−12 |

Various Data
Zoom ratio 2.06

| | Wide angle | Intermediate | Telephoto |
|---|---|---|---|
| Focal length | 16.48 | 24.46 | 33.95 |
| F number | 4.08 | 4.08 | 4.12 |
| Half angle of view | 48.64 | 41.13 | 32.51 |
| Image height | 18.72 | 21.36 | 21.64 |
| Total optical length | 122.38 | 122.38 | 122.38 |
| BF | 14.00 | 14.00 | 14.00 |
| d 7 | 22.20 | 14.45 | 6.70 |
| d12 | 1.50 | 9.25 | 17.01 |
| d18 | 14.55 | 7.59 | 1.50 |
| d23 | 1.77 | 1.43 | 3.29 |
| d27 | 2.17 | 9.47 | 13.71 |

Zoom Lens Unit Data

| Unit | Start surface | Focal length |
|---|---|---|
| 1 | 1 | −20.75 |
| 2 | 8 | 31.31 |
| 3 | 13 | −56.76 |
| 4 | 19 | 21.37 |
| 5 | 24 | −22.10 |
| 6 | 28 | 104.98 |

### Eleventh Numerical Example

Unit mm
Surface Data

| Surface number | r | d | nd | νd |
|---|---|---|---|---|
| 1 | 75.798 | 2.15 | 1.76450 | 49.1 |
| 2* | 20.955 | 7.50 | | |
| 3 | −148.504 | 1.20 | 1.53775 | 74.7 |
| 4 | 40.273 | 5.37 | | |
| 5 | 52.733 | 2.58 | 1.77047 | 29.7 |
| 6 | 247.572 | (variable) | | |
| 7 | 48.383 | 1.00 | 1.85478 | 24.8 |
| 8 | 21.608 | 3.53 | 1.59282 | 68.6 |
| 9 | 181.976 | 0.15 | | |
| 10 | 36.618 | 2.69 | 1.83481 | 42.7 |
| 11 | −462.575 | (variable) | | |
| 12 (aperture) | ∞ | 1.99 | | |
| 13 | −61.920 | 2.68 | 1.80810 | 22.8 |
| 14 | −17.654 | 1.00 | 1.90043 | 37.4 |
| 15 | −782.687 | (variable) | | |
| 16* | 40.869 | 7.00 | 1.49700 | 81.5 |
| 17* | −24.624 | 0.15 | | |
| 18 | 29.423 | 6.48 | 1.49700 | 81.5 |
| 19 | −31.636 | 0.90 | 1.85478 | 24.8 |
| 20 | −170.020 | (variable) | | |
| 21 | 29.391 | 1.00 | 1.85150 | 40.8 |
| 22 | 18.203 | 6.91 | | |
| 23* | −14.187 | 1.50 | 1.76450 | 49.1 |
| 24* | −26.077 | (variable) | | |
| 25 | −57.883 | 2.82 | 1.90043 | 37.4 |
| 26 | −36.703 | 14.00 | | |
| Image plane | ∞ | | | |

Aspherical Surface Data
2nd surface

| | | | | |
|---|---|---|---|---|
| K = 0.00000e+00 | A4 = −4.42189e−06 | A6 = −2.03165e−08 | A8−3.28080e−11 | A10 = −1.68898e−13 |

16th surface

| | | | |
|---|---|---|---|
| K = 0.00000e+00 | A4 = −3.87009e−06 | A6 = −1.70155e−08 | A8 = −1.92942e−10 |

17th surface

| | | | | |
|---|---|---|---|---|
| K = 0.00000e+00 | A4 = 1.50150e−05 | A6 = −3.01438e−08 | A8 = −8.39812e−11 | A10 = −6.69050e−13 |

23rd surface

| | | | |
|---|---|---|---|
| K = 0.00000e+00 | A4 = 1.92612e−04 | A6 = −1.47567e−06 | A8 = 4.79928e−09 |

24th surface

| | | | | |
|---|---|---|---|---|
| K = 0.00000e+00 | A4 = 1.51969e−04 | A6 = −1.37099e−06 | A8 = 5.56233e−09 | A10 = −8.39664e−12 |

Various Data
Zoom ration 2.35

| | Wide angle | Intermediate | Telephoto |
|---|---|---|---|
| Focal length | 20.60 | 32.42 | 48.50 |
| F number | 4.08 | 4.08 | 4.12 |
| Half angle of view | 42.98 | 33.52 | 24.04 |
| Image height | 19.20 | 21.48 | 21.63 |
| Total optical length | 117.00 | 117.00 | 117.00 |
| BF | 14.00 | 14.00 | 14.00 |
| d 6 | 22.92 | 12.21 | 1.50 |
| d11 | 1.50 | 12.21 | 22.92 |
| d15 | 14.67 | 8.09 | 1.50 |
| d20 | 2.54 | 1.43 | 2.91 |
| d24 | 2.77 | 10.46 | 15.57 |

Zoom Lens Unit Data

| Unit | Start surface | Focal length |
|---|---|---|
| 1 | 1 | −33.65 |
| 2 | 7 | 37.80 |
| 3 | 12 | −58.15 |
| 4 | 16 | 23.62 |
| 5 | 21 | −23.67 |
| 6 | 25 | 104.78 |

### Twelfth Numerical Example

Unit mm
Surface Data

| Surface number | r | d | nd | νd |
|---|---|---|---|---|
| 1 | 53.669 | 2.00 | 1.76450 | 49.1 |
| 2* | 22.183 | 2.84 | | |
| 3 | 38.357 | 1.50 | 1.90043 | 37.4 |
| 4 | 18.785 | 9.89 | | |
| 5 | −44.427 | 1.20 | 1.49700 | 81.5 |
| 6 | 49.651 | 0.15 | | |
| 7 | 44.261 | 3.66 | 1.77047 | 29.7 |
| 8 | −230.038 | (variable) | | |
| 9 | 45.949 | 1.00 | 1.80610 | 33.3 |
| 10 | 19.217 | 3.47 | 1.59282 | 68.6 |
| 11 | −1161.013 | 0.15 | | |
| 12 | 30.492 | 2.63 | 1.59282 | 68.6 |
| 13 | −236.362 | (variable) | | |
| 14 (aperture) | ∞ | 1.59 | | |
| 15 | −234.100 | 2.80 | 1.76182 | 26.5 |
| 16 | −19.123 | 1.00 | 1.85150 | 40.8 |
| 17 | 144.749 | (variable) | | |
| 18* | 30.612 | 7.00 | 1.49700 | 81.5 |
| 19* | −26.983 | 0.15 | | |
| 20 | 34.872 | 5.95 | 1.49700 | 81.5 |
| 21 | −28.140 | 0.90 | 1.85478 | 24.8 |
| 22 | −85.522 | (variable) | | |
| 23 | 37.240 | 1.00 | 1.90043 | 37.4 |
| 24 | 19.516 | 5.60 | | |
| 25* | −17.122 | 1.50 | 1.76450 | 49.1 |
| 26* | −30.456 | (variable) | | |
| 27 | −85.253 | 2.94 | 1.65160 | 58.5 |
| 28 | −42.164 | 14.00 | | |
| Image plane | ∞ | | | |

Aspherical Surface Data
2nd surface

| | | | | |
|---|---|---|---|---|
| K = 0.00000e+00 | A4 = −7.07546e−06 | A6 = −2.29052e−08 | A8 = 2.47534e−11 | A10 = −1.17938e−13 |

18th surface

| | | | |
|---|---|---|---|
| K = 0.00000e+00 | A4 = −8.44890e−06 | A6 = −3.82470e−09 | A8 = −5.75965e−11 |

19th surface

| | | | | |
|---|---|---|---|---|
| K = 0.00000e+00 | A4 = 1.76346e−05 | A6 = −3.88394e−08 | A8 = −9.63881e−12 | A10 = −8.53919e−14 |

25th surface

| | | | |
|---|---|---|---|
| K = 0.00000e+00 | A4 = 1.70156e−04 | A6 = −1.66700e−06 | A8 = 5.33737e−09 |

26th surface

| | | | | |
|---|---|---|---|---|
| K = 0.00000e+00 | A4 = 1.53337e−04 | A6 = −1.50071e−06 | A8 = 6.44506e−09 | A10 = −8.76750e−12 |

Various Data
Zoom ratio 2.06

| | Wide angle | Intermediate | Telephoto |
|---|---|---|---|
| Focal length | 16.48 | 24.29 | 33.95 |
| F number | 4.08 | 4.08 | 4.12 |
| Half angle of view | 48.72 | 40.93 | 32.51 |
| Image height | 18.77 | 21.06 | 21.64 |
| Total optical length | 115.00 | 115.00 | 115.00 |
| BF | 14.00 | 14.00 | 14.00 |
| d 8 | 20.80 | 13.08 | 5.36 |
| d13 | 1.50 | 9.22 | 16.94 |
| d17 | 15.35 | 7.91 | 1.50 |
| d22 | 2.10 | 1.43 | 3.02 |
| d26 | 2.31 | 10.42 | 15.24 |

Zoom Lens Unit Data

| Unit | Start surface | Focal length |
|---|---|---|
| 1 | 1 | −22.50 |
| 2 | 9 | 35.28 |
| 3 | 14 | −71.91 |
| 4 | 18 | 22.64 |
| 5 | 23 | −24.10 |
| 6 | 27 | 124.67 |

### Thirteenth Numerical Example

Unit mm
Surface Data

| Surface number | r | d | nd | νd |
|---|---|---|---|---|
| 1 | 55.313 | 1.50 | 1.80400 | 46.5 |
| 2 | 26.509 | 7.07 | | |
| 3 | 84.457 | 1.50 | 1.72916 | 54.7 |
| 4 | 31.552 | 6.21 | | |
| 5 | −473.440 | 1.20 | 1.59282 | 68.6 |
| 6 | 58.611 | 0.15 | | |
| 7 | 37.921 | 3.46 | 1.85478 | 24.8 |
| 8 | 77.200 | (variable) | | |
| 9 | −187.319 | 1.50 | 1.80610 | 33.3 |
| 10 | 38.484 | 9.00 | 1.65160 | 58.5 |
| 11 | −49.041 | 2.46 | | |
| 12* | 36.407 | 6.90 | 1.49700 | 81.7 |
| 13* | −125.224 | (variable) | | |
| 14 (aperture) | ∞ | 2.44 | | |
| 15 | −73.514 | 1.00 | 1.69680 | 55.5 |
| 16 | 44.586 | 2.50 | 2.00069 | 25.5 |
| 17 | 339.796 | 1.69 | | |
| 18 | −49.780 | 1.00 | 1.61340 | 44.3 |
| 19 | −242.601 | (variable) | | |
| 20* | 32.454 | 7.71 | 1.49700 | 81.7 |
| 21* | −28.847 | 0.15 | | |
| 22 | 40.658 | 5.73 | 1.59282 | 68.6 |
| 23 | −36.950 | 1.00 | 1.85478 | 24.8 |
| 24 | −522.178 | (variable) | | |
| 25 | 53.509 | 1.50 | 1.75500 | 52.3 |
| 26 | 19.292 | 8.16 | | |
| 27 | −19.910 | 1.50 | 1.76450 | 49.1 |
| 28* | −28.755 | (variable) | | |
| 29 | −56.999 | 6.04 | 1.49700 | 81.7 |
| 30 | −27.118 | 13.50 | | |
| Image plane | ∞ | | | |

Aspherical Surface Data
12th surface

| | | | | |
|---|---|---|---|---|
| K = 0.00000e+00 | A4 = −4.98848e−06 | A6 = −4.09630e−09 | A8 = 1.35299e−12 | A10 = −5.99270e−15 |

13th surface

| | | |
|---|---|---|
| K = 0.00000e+00 | A4 = −5.36741e−06 | A6 = 1.26727e−09 |

20th surface

| | | | |
|---|---|---|---|
| K = 0.00000e+00 | A4 = −1.14938e−05 | A6 = 2.45098e−09 | A8 = −1.52978e−11 |

21st surface

| | | |
|---|---|---|
| K = 0.00000e+00 | A4 = 9.02714e−06 | A6 = −5.81930e−09 |

28th surface

| | | | | |
|---|---|---|---|---|
| K = 0.00000e+00 | A4 = 3.19122e−06 | A6 = 3.75828e−09 | A8 = 1.37350e−10 | A10 = −2.86411e−13 |

Various Data
Zoom ratio 2.35

| | Wide angle | Intermediate | Telephoto |
|---|---|---|---|
| Focal length | 18.54 | 29.09 | 43.65 |
| F number | 2.91 | 2.91 | 2.91 |
| Half angle of view | 44.84 | 36.29 | 26.37 |
| Image height | 18.44 | 21.37 | 21.64 |
| Total optical length | 150.00 | 150.00 | 150.00 |
| BF | 13.50 | 13.50 | 13.50 |
| d 8 | 33.23 | 20.02 | 6.82 |
| d13 | 1.50 | 14.70 | 27.91 |
| d19 | 14.87 | 8.49 | 1.50 |
| d24 | 2.84 | 1.72 | 3.38 |
| d28 | 2.69 | 10.19 | 15.52 |

Zoom Lens Unit Data

| Unit | Start surface | Focal length |
|---|---|---|
| 1 | 1 | −31.72 |
| 2 | 9 | 42.58 |
| 3 | 14 | −64.35 |
| 4 | 20 | 24.76 |
| 5 | 25 | −27.02 |
| 6 | 29 | 97.54 |

Various values in each of the numerical examples are summarized in Table 1 below.

TABLE 1

| | ex. 1 | ex. 2 | ex. 3 | ex. 4 | ex. 5 | ex. 6 | ex. 7 | ex. 8 | ex. 9 | ex. 10 | ex. 11 | ex. 12 | ex. 13 |
|---|---|---|---|---|---|---|---|---|---|---|---|---|---|
| fw | 20.60 | 20.60 | 20.60 | 24.72 | 24.72 | 24.72 | 20.60 | 18.54 | 18.54 | 16.48 | 20.60 | 16.48 | 18.54 |
| ft | 48.50 | 48.50 | 48.50 | 48.50 | 58.20 | 58.20 | 58.20 | 43.65 | 43.65 | 33.95 | 48.50 | 33.95 | 43.65 |
| f1 | −27.81 | −28.63 | −29.98 | −27.30 | −28.00 | −29.99 | −28.76 | −22.28 | −24.08 | −20.75 | −33.65 | −22.50 | −31.72 |
| fm1 | −49.61 | −49.53 | −44.06 | −43.65 | −63.29 | −71.05 | −47.23 | −63.06 | −54.31 | −56.76 | −58.15 | −71.91 | −64.35 |
| fm2 | 22.93 | 25.60 | 24.32 | 40.79 | 348.73 | 455.17 | 22.32 | 22.22 | 22.13 | 21.37 | 23.62 | 22.64 | 24.76 |
| fm3 | −22.97 | −27.30 | −27.56 | — | — | — | −19.69 | −21.20 | −22.08 | −22.10 | −23.67 | −24.10 | −27.02 |
| fa t | 33.50 | 32.28 | 32.41 | 28.94 | 29.68 | 30.63 | 31.18 | 32.49 | 31.86 | 31.31 | 37.80 | 35.28 | 42.58 |
| TLw | 111.50 | 114.00 | 114.00 | 103.80 | 107.20 | 105.45 | 116.50 | 111.50 | 111.50 | 108.38 | 103.00 | 101.00 | 136.50 |
| Skw | 13.50 | 13.50 | 13.50 | 14.35 | 20.30 | 17.55 | 13.50 | 13.50 | 13.50 | 14.00 | 14.00 | 14.00 | 13.50 |
| D1 | 16.16 | 17.89 | 18.26 | 16.28 | 16.01 | 16.34 | 17.69 | 17.91 | 17.02 | 20.49 | 18.80 | 21.25 | 21.09 |
| L1 | 6.30 | 6.60 | 6.85 | 4.93 | 4.82 | 4.77 | 5.96 | 6.17 | 6.56 | 7.47 | 7.50 | 9.89 | 7.07 |
| ma | −21.45 | −21.52 | −21.82 | −15.78 | −22.73 | −22.45 | −26.46 | −18.85 | −19.93 | −15.51 | −21.42 | −15.44 | −26.41 |
| mb | −12.58 | −11.36 | −9.84 | −8.24 | −13.34 | −13.25 | −12.69 | −17.36 | −14.54 | −13.05 | −13.17 | −13.85 | −13.37 |
| xa t | 33.81 | 40.64 | 38.00 | 30.76 | 48.01 | 45.73 | 44.04 | 28.58 | 33.16 | 26.49 | 32.28 | 25.79 | 50.20 |
| xb w | 40.76 | 40.25 | 37.82 | 26.86 | 34.57 | 34.25 | 39.31 | 49.32 | 41.62 | 40.56 | 41.15 | 39.55 | 43.47 |
| νdn | 81.65 | 81.65 | 81.65 | 81.65 | 81.65 | 81.65 | 81.65 | 81.65 | 81.65 | 81.54 | 74.70 | 81.54 | 68.62 |
| Skw/fw | 0.655 | 0.655 | 0.655 | 0.581 | 0.821 | 0.710 | 0.655 | 0.728 | 0.728 | 0.850 | 0.680 | 0.850 | 0.728 |
| D1/TLw | 0.145 | 0.157 | 0.160 | 0.157 | 0.149 | 0.155 | 0.152 | 0.161 | 0.153 | 0.189 | 0.183 | 0.210 | 0.155 |
| ft/fw | 2.354 | 2.354 | 2.354 | 1.962 | 2.354 | 2.354 | 2.825 | 2.354 | 2.354 | 2.060 | 2.354 | 2.060 | 2.354 |
| νdn | 81.650 | 81.650 | 81.650 | 81.650 | 81.650 | 81.650 | 81.650 | 81.650 | 81.650 | 81.540 | 74.700 | 81.540 | 68.621 |
| L1/D1 | 0.390 | 0.369 | 0.375 | 0.303 | 0.301 | 0.292 | 0.337 | 0.345 | 0.386 | 0.365 | 0.399 | 0.466 | 0.335 |
| −f1/fa t | 0.830 | 0.887 | 0.925 | 0.943 | 0.944 | 0.979 | 0.922 | 0.686 | 0.756 | 0.663 | 0.890 | 0.638 | 0.745 |
| f1/fm1 | 0.561 | 0.578 | 0.681 | 0.625 | 0.442 | 0.422 | 0.609 | 0.353 | 0.443 | 0.366 | 0.579 | 0.313 | 0.493 |
| −f1/fw | 1.350 | 1.390 | 1.455 | 1.104 | 1.133 | 1.213 | 1.396 | 1.202 | 1.299 | 1.259 | 1.634 | 1.365 | 1.711 |
| fa t/ft | 0.691 | 0.666 | 0.668 | 0.597 | 0.510 | 0.526 | 0.536 | 0.744 | 0.730 | 0.922 | 0.779 | 1.039 | 0.975 |
| xa t/TLw | 0.303 | 0.356 | 0.333 | 0.296 | 0.448 | 0.434 | 0.378 | 0.256 | 0.297 | 0.244 | 0.313 | 0.255 | 0.368 |
| xb w/TLw | 0.366 | 0.353 | 0.332 | 0.259 | 0.322 | 0.325 | 0.337 | 0.442 | 0.373 | 0.374 | 0.400 | 0.392 | 0.318 |
| \| ma \|/TLw | 0.192 | 0.189 | 0.191 | 0.152 | 0.212 | 0.213 | 0.227 | 0.169 | 0.179 | 0.143 | 0.208 | 0.153 | 0.193 |
| \| mb \|/TLw | 0.113 | 0.100 | 0.086 | 0.079 | 0.124 | 0.126 | 0.109 | 0.156 | 0.130 | 0.120 | 0.128 | 0.137 | 0.098 |
| fm2/(−fm3) | 0.998 | 0.938 | 0.882 | — | — | — | 1.133 | 1.048 | 1.002 | 0.967 | 0.998 | 0.939 | 0.916 |

### [Image Capturing Apparatus]

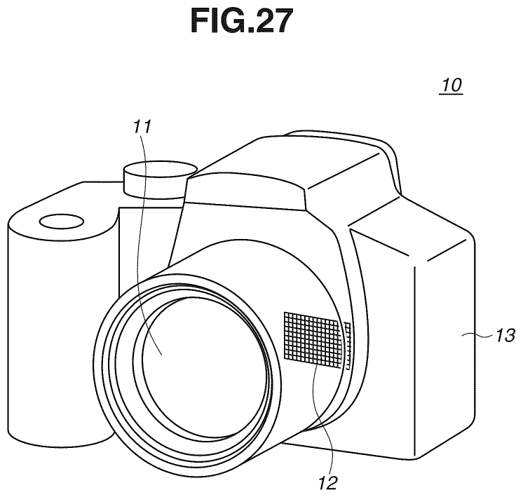

Next, an exemplary embodiment of a digital still camera (image capturing apparatus) that uses the zoom lens L0 as an imaging optical system will be described with reference to FIG. 27. FIG. 27 illustrates a camera main body 10 and an imaging optical system 11 configured with the zoom lens L0 according to any of the first to thirteenth exemplary embodiments. A solid-state imaging element (photoelectric conversion element) 12, such as a CCD sensor or a CMOS sensor, is built into the camera main body 10, receives an optical image formed by the imaging optical system 11, and performs photoelectric conversion thereon. The camera main body 10 may be a single-lens reflex camera that includes a quick-return mirror or a mirrorless camera without a quick-return mirror.

In this way, an optical system according to an embodiment of the disclosure is applied to an image capturing apparatus such as a digital still camera, and thus an image capturing apparatus including a small lens can be achieved.

### [Image Capturing System]

An image capturing system (a surveillance camera system) may be configured that includes the zoom lens L0 according to each of the exemplary embodiments and a control unit that controls the zoom lens L0. In this case, the control unit can control the zoom lens L0 so that each lens unit, the focusing unit, and the image stabilization unit are moved as described above during zooming, focusing, and image blur correction. In this regard, the control unit does not need to be configured integrally with the zoom lens L0 and may be configured separately from the zoom lens L0.

For example, a configuration may be adopted in which the control unit (control device) arranged remotely from a drive unit that drives each lens in the zoom lens includes a transmission unit that transmits a control signal (command) for controlling the zoom lens. The control unit can remotely control the zoom lens.

Further, a configuration may be adopted in which the control unit is provided with an operation unit such as a controller and a button for remotely controlling the zoom lens and controls the zoom lens in response to an input performed by a user on the operation unit. For example, a zoom in button and a zoom out button may be provided as the operation unit. In this case, the control unit may be configured to transmit a signal to the drive unit of the zoom lens so that the magnification of the zoom lens increases when a user presses the zoom in button and decreases when the user presses the zoom out button.

The image capturing system may include a display unit such as a liquid crystal panel that displays information (movement state) related to zooming of the zoom lens. The information related to zooming of the zoom lens includes, for example, a zoom ratio (zoom state) and a movement amount (movement state) of each lens unit. In this case, a user can remotely operate the zoom lens via the operation unit while viewing the information related to zooming of the zoom lens displayed on the display unit. In this regard, for example, a touch panel may be adopted to integrate the display unit and the operation unit.

The exemplary embodiments and examples of the disclosure are described above, but the disclosure is not limited to these exemplary embodiments and examples, and various combinations, modifications, and variations can be made within the scope of the disclosure.

While the exemplary embodiments of disclosure has been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-178515, filed Oct. 16, 2023, which is hereby incorporated by reference herein in its entirety.

What is claimed is:

1. A zoom lens comprising a first lens unit having negative refractive power, a second lens unit, an intermediate unit including one or more lens units, and a final lens unit, which are arranged in this order from an object side to an image side and in which an interval between adjacent lens units changes during zooming,
wherein the first lens unit includes two or more lenses,
wherein the intermediate unit includes a first intermediate lens unit and a second intermediate lens unit arranged adjacent to the image side of the first intermediate lens unit, and
wherein the first lens unit and the first intermediate lens unit do not move during zooming.

2. The zoom lens according to claim 1, wherein a following inequality is satisfied:
$$0.04 < D 1 / TLw < 0.25 ,$$
where D1 is a distance on an optical axis from a surface vertex of a lens surface closest to the object side in the first lens unit to a surface vertex of a lens surface closest to the image side in the first lens unit, and TLw is a distance on the optical axis at a wide angle end from a surface vertex of a lens surface closest to the object side in the zoom lens to a surface vertex of a lens surface closest to the image side in the zoom lens.

3. The zoom lens according to claim 1, wherein a following inequality is satisfied:
$$0.05 < Skw / fw < 1.5 ,$$
where Skw is an air equivalent distance on an optical axis at a wide angle end from a surface vertex of a lens surface closest to the image side in the zoom lens to an image plane, and fw is a focal length of an overall system at the wide angle end in the zoom lens.

4. The zoom lens according to claim 1, wherein a following inequality is satisfied:
$$1.65 < ft / fw < 6. ,$$
where fw is a focal length of an overall system at a wide angle end in the zoom lens, and ft is a focal length of the overall system at a telephoto end in the zoom lens.

5. The zoom lens according to claim 1, wherein a following inequality is satisfied:
$$vdn > 50 ,$$
where vdn is a largest Abbe number in Abbe numbers of a material of a negative lens included in the first lens unit.

6. The zoom lens according to claim 1, wherein the final lens unit does not move during zooming.

7. The zoom lens according to claim 1, wherein a following inequality is satisfied:
$$0.1 < Da / D 1 < 0.6 ,$$
where Da is a largest air gap in air gaps on an optical axis of the first lens unit, and D1 is a distance on an optical axis from a surface vertex of a lens surface closest to the object side in the first lens unit to a surface vertex of a lens surface closest to the image side in the first lens unit.

8. The zoom lens according to claim 1, wherein the first intermediate lens unit is a lens unit having negative refractive power.

9. The zoom lens according to claim 1, wherein a lens unit that is arranged closer to the object side than the first intermediate lens unit and moves during zooming moves toward the object side during zooming from a wide angle end to a telephoto end.

10. The zoom lens according to claim 1, wherein a lens unit that is arranged between the first lens unit and the first intermediate lens unit is a lens unit having positive refractive power.

11. The zoom lens according to claim 1, wherein a lens unit that is arranged closer to the image side than the first intermediate lens unit and moves during zooming moves toward the object side during zooming from a wide angle end to a telephoto end.

12. The zoom lens according to claim 1, wherein the second intermediate lens unit is a lens unit having positive refractive power.

13. The zoom lens according to claim 1, wherein the second intermediate lens unit includes a lens having an aspherical lens surface.

14. The zoom lens according to claim 1, wherein the first intermediate lens unit includes an aperture stop.

15. The zoom lens according to claim 1, wherein a lens unit having negative refractive power is arranged closer to the image side than the first intermediate lens unit.

16. The zoom lens according to claim 1, wherein a lens that is arranged closest to the image side in the first lens unit is a positive lens.

17. The zoom lens according to claim 1, wherein a lens that is arranged closest to the object side in the first lens unit is a negative lens.

18. The zoom lens according to claim 1, wherein a lens that is arranged closest to the object side in the first lens unit is a lens with a convex surface facing the object side.

19. The zoom lens according to claim 1, wherein a following inequality is satisfied:
$$0.48 < ( - f 1 ) / fa\_t < 1.27 ,$$
where f1 is a focal length of the first lens unit, and fa_t is a combined focal length of a lens arranged between the first lens unit and the first intermediate lens unit at a telephoto end.

20. The zoom lens according to claim 1, wherein a following inequality is satisfied:
$$0.25 < f 1 / fm 1 < 0.88 ,$$
where f1 is a focal length of the first lens unit, and fm1 is a focal length of the first intermediate lens unit.

21. The zoom lens according to claim 1, wherein a following inequality is satisfied:
$$0.83 < ( - f 1 ) / fw < 1.97 ,$$
where f1 is a focal length of the first lens unit, and fw is a focal length of an overall system at the wide angle end in the zoom lens.

22. The zoom lens according to claim 1, wherein a following inequality is satisfied:
$$0.38 < fa\_t / ft < 1.51 ,$$
where fa_t is a combined focal length of a lens arranged between the first lens unit and the first intermediate lens unit at a telephoto end, and ft is a focal length of the overall system at a telephoto end in the zoom lens.

23. The zoom lens according to claim 1, wherein a following inequality is satisfied:
$$0.2 < xa\_t / TLw < 0.56 ,$$
where xa_t is a distance on an optical axis at a telephoto end from a surface vertex of a lens surface closest to the object side in lenses arranged between the first lens unit and the first intermediate lens unit to a surface vertex of a lens surface closest to the object side in the first intermediate lens unit, and TLw is a distance on the optical axis at a wide angle end from a surface vertex of a lens surface closest to the object side in the zoom lens to a surface vertex of a lens surface closest to the image side in the zoom lens.

24. The zoom lens according to claim 1, wherein a following inequality is satisfied:
$$0.19 < xb\_w / TLw < 0.55 ,$$
where xb_w is a distance on an optical axis at a wide angle end from a surface vertex of a lens surface closest to the image side in the first intermediate lens unit to a surface vertex of a lens surface closest to the image side in lenses arranged between the first intermediate lens unit and the final lens unit, and TLw is a distance on the optical axis at a wide angle end from a surface vertex of a lens surface closest to the object side in the zoom lens to a surface vertex of a lens surface closest to the image side in the zoom lens.

25. The zoom lens according to claim 1, wherein a following inequality is satisfied:
$$0.09 < \vert ma \vert / TLw < 0.27 ,$$
where ma is a largest movement amount of a lens unit arranged between the first lens unit and the first intermediate lens unit during zooming from a wide angle end to a telephoto end, and TLw is a distance on the optical axis at a wide angle end from a surface vertex of a lens surface closest to the object side in the zoom lens to a surface vertex of a lens surface closest to the image side in the zoom lens.

26. The zoom lens according to claim 1, wherein a following inequality is satisfied:
$$0.06 < \vert mb \vert / TLw < 0.2 ,$$
where mb is a largest movement amount of a lens unit arranged between the first intermediate lens unit and the final lens unit during zooming from a wide angle end to a telephoto end, and TLw is a distance on the optical axis at a wide angle end from a surface vertex of a lens surface closest to the object side in the zoom lens to a surface vertex of a lens surface closest to the image side in the zoom lens.

27. The zoom lens according to claim 1, wherein a third intermediate lens unit having negative refractive power is arranged adjacent to the image side of the second intermediate lens unit.

28. The zoom lens according to claim 27, wherein a following inequality is satisfied:
$$0.71 < fm 2 / ( - fm 3 ) < 1.36 ,$$
where fm2 is a focal length of the second intermediate lens unit, and fm3 is a focal length of the third intermediate lens unit.

29. The zoom lens according to claim 1, wherein lens units that move during zooming among lens units included in the zoom lens are all moved by an actuator.

30. An image capturing apparatus comprising the zoom lens according to claim 1.

31. The image capturing apparatus according to claim 30, further comprising an imaging element configured to photoelectrically convert an optical image formed by the zoom lens.
